(19) United States
(12) Patent Application Publication
(10) Pub. No.: US 2023/0200307 A1
(43) Pub. Date: Jun. 29, 2023

(54) VENTILATION SYSTEM FOR PLANT CULTIVATION

(71) Applicant: Integrated Hydro Solutions Inc., Kelseyville, CA (US)

(72) Inventors: Leigh Michael Zalusky, Cobb, CA (US); Gregory Lewis Panella, Finley, CA (US)

(21) Appl. No.: 18/089,805

(22) Filed: Dec. 28, 2022

Related U.S. Application Data
(60) Provisional application No. 63/395,015, filed on Aug. 4, 2022.
(60) Provisional application No. 63/294,155, filed on Dec. 28, 2021.

(51) Int. Cl. A01G 9/24; F04D 29/42; F04D 25/08

(52) U.S. Cl. CPC A01G 9/24; F04D 29/4226; F04D 25/08

(57) ABSTRACT

Ventilation systems for a vertical growing system for growing plants include a centrifugal fan incorporated into an air passage to compress ambient air and direct the compressed air into an elongated duct assembly.

### CROSS-REFERENCE TO RELATED APPLICATIONS

The present application claims priority to U.S. Provisional Application No. 63/395,015, filed Aug. 4, 2022; and U.S. Provisional Application No. 63/294,155, filed Dec. 28, 2021, the disclosures of which are incorporated herein by reference in their entirety.

### TECHNOLOGICAL FIELD

This disclosure relates to a ventilation system for use in horticultural or agricultural operations.

### BACKGROUND

Air stratification and excess water/nutrient collection are two problems associated with enclosed vertical agricultural operations. Air stratification can occur when insufficient ventilation is present, and can be especially problematic for the lower levels of racked operations where the canopy of one level of crop tends to prevent the downward circulation of air from vents or fans, which are typically present on the ceiling. Stratification is the layering of air due to density variations caused by temperature, humidity, carbon dioxide depletion etc. and is detrimental to the health of the crops being grown.

Enclosed vertical agricultural operations require that the racking systems provide a method of collecting and consolidating excess water and nutrients draining from the individual growing containers. Fluid that is not consolidated and removed from the operation can foster the growth of mold, fungus and other organisms detrimental to the health of the crops.

Current conventional solutions depend on a combination of technologies to implement drainage and de-stratification using separate trays and combinations of duct work and fans mounted below the growing trays, interfering with the positioning of lighting and potentially decreasing possible vertical density.

### SUMMARY OF THE DISCLOSED SUBJECT MATTER

To address the problems in the prior art, an air box for a ventilation system for plant cultivation is provided.

A first aspect provides a system for plant cultivation, comprising a ventilation system comprising an air box comprising an air passage extending from an inlet opening in a first end of the air box to an outlet opening in a second end of the air box, the air box comprising a centrifugal fan or tangential fan disposed in the air passage configured to move air from the first end to the second end of the air box.

Embodiments include the following, alone or in any combination.

The system may comprise a centrifugal fan having a vertical axis of rotation.

The system may comprise two or more centrifugal fans, each centrifugal fan having a vertical axis of rotation.

The system may comprise a centrifugal fan having a horizontal axis of rotation.

The system wherein the centrifugal fan comprises a volute housing wherein the outlet of the volute housing is in fluid communication with the outlet opening in the second end of the air box.

The system may comprise a tangential fan having a horizontal axis of rotation, wherein the tangential fan directs air toward the outlet opening.

The outlet opening may be in fluid communication with an elongated duct assembly comprising one or more air passages, the duct assembly having a first end in fluid communication with the outlet opening, a second end opposed to the first end configured to be either closed or in fluid communication with a second duct assembly, and a plurality of orifices in the one or more air passages to distribute air out of the one or more air passages.

The plurality of orifices are configured to direct air from the duct assembly to above the duct assembly; or direct air from the duct assembly to below the duct assembly; or direct air from the duct assembly to above and below the duct assembly.

The duct assembly may be engaged to an air box comprising a first air chamber extending from an inlet opening in a first end of the air box and a second air chamber extending from an outlet opening in a second end of the air box and a centrifugal fan or a tangential fan disposed between the first air chamber and the second air chamber, the fan in fluid connectivity with the first air chamber and the second air chamber to define an air passage configured to move air from the first end to the second end of the air box.

The second air chamber is configured to fit within an air passage within the duct assembly and the outlet directs air into an air passage within the duct assembly.

The centrifugal fan has a vertical axis of rotation and an entry in fluid communication with the first air chamber; and the centrifugal fan is disposed within the second air chamber.

A second aspect provides a system for plant cultivation, comprising a ventilation system comprising an air box comprising a first air chamber extending from an inlet opening in a first end of the air box and a second air chamber extending from an outlet opening in a second end of the air box and a centrifugal fan or a tangential fan disposed between the first air chamber and the second air chamber, the fan in fluid connectivity with the first air chamber and the second air chamber to define an air passage configured to move air from the first end to the second end of the air box.

Embodiments of this aspect include the following, alone or in any combination.

The air box is configured to engage a duct assembly to draw ambient air into the air box through the inlet opening and direct compressed air through the outlet opening into the duct assembly.

The outlet opening is in fluid communication with an elongated duct assembly comprising one or more air passages, the duct assembly having a first end in fluid communication with the outlet opening, a second end opposed to the first end configured to be either closed or in fluid communication with a second duct assembly, and a plurality of orifices in the one or more air passages to distribute air out of the one or more air passages.

The second air chamber is configured to fit within an air passage within the duct assembly and the outlet directs air into an air passage within the duct assembly.

The centrifugal fan has a vertical axis of rotation and an entry in fluid communication with the first air chamber.

The centrifugal fan is disposed within the second air chamber.

The plurality of orifices are configured to direct air from the duct assembly to above the duct assembly; or direct air from the duct assembly to below the duct assembly; or direct air from the duct assembly to above and below the duct assembly.

The system may further comprise a tray comprising opposed sides and opposed ends defining a perimeter of the tray, and a raised region disposed within the perimeter of the tray.

The raised region of the tray may comprises a plurality of alternating parallel ridges disposed between the side walls and a plurality of valleys formed between adjacent ridges of the plurality of ridges, wherein one or more of the plurality of valleys are in fluid communication with a gutter; and optionally one or more of a plurality of holes in one or more of the plurality of ridges in fluid communication with the plurality of orifices in the top panel of the duct assembly to direct air from the duct assembly to above the tray.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A shows a schematic perspective view of an air box according to an embodiment of the disclosed subject matter.

FIG. 1B shows a perspective view of a centrifugal fan, according to an embodiment of the disclosed subject matter.

FIG. 1C shows another schematic perspective view of an air box, according to an embodiment of the disclosed subject matter.

FIG. 1D shows another schematic perspective view of an air box, according to an embodiment of the disclosed subject matter.

FIGS. 1E-1G show views of another are box, according to an embodiment of the disclosed subject matter.

FIGS. 2A and 2B show side and front views of a prior art ventilation system.

FIGS. 3A and 3B show side and front views of a ventilation system according to an embodiment of the disclosed subject matter.

FIG. 4 shows a cross-section side view of a ventilation system according to an embodiment of the disclosed subject matter.

FIG. 5A shows a cross-section side view of a ventilation system view according to another embodiment of the disclosed subject matter.

FIG. 5B shows a perspective view of a centrifugal fan, according to another embodiment of the disclosed subject matter.

FIG. 6A shows a cross-section side view of a ventilation system view according to another embodiment of the disclosed subject matter.

FIG. 6B shows a perspective view of a tangential fan, according to another embodiment of the disclosed subject matter.

FIG. 7A shows a front view of a ventilation system engaged to a rack system according to an embodiment of the disclosed subject matter.

FIG. 7B shows a side view of a ventilation system engaged to a rack system and a duct system according to an embodiment of the disclosed subject matter.

FIG. 7C shows a perspective view of a duct system according to an embodiment of the disclosed subject matter.

FIG. 7D shows a bottom view of a duct system according to an embodiment of the disclosed subject matter.

FIG. 7E shows a perspective view of a duct system according to an embodiment of the disclosed subject matter.

FIG. 8A shows a side view of a ventilation system engaged to a rack system with trays overlying a duct system according to an embodiment of the disclosed subject matter.

FIG. 8B shows a top perspective view of a tray according to an embodiment of the disclosed subject matter.

FIG. 8C shows a bottom perspective view of a tray according to an embodiment of the disclosed subject matter.

FIG. 8D shows a close-up perspective cutaway view of a tray according to an embodiment of the disclosed subject matter.

FIG. 9A shows an exploded view of a ventilation system according to another embodiment of the disclosed subject matter.

FIG. 9B shows a top view of a ventilation system according to another embodiment of the disclosed subject matter.

FIG. 9C shows a close-up view of a ventilation system according to another embodiment of the disclosed subject matter.

FIGS. 10A-F show aspects of a ventilation system according to another embodiment of the disclosed subject matter.

FIG. 11 shows a schematic view of a ventilation system according to another embodiment of the disclosed subject matter.

FIG. 12 shows a schematic view of a ventilation system according to another embodiment of the disclosed subject matter.

FIGS. 13A-F show aspects of a ventilation system according to another embodiment of the disclosed subject matter.

FIGS. 14A-B show aspects of a ventilation system according to the embodiment shown in FIGS. 13A-F engaged to a duct assembly according to an embodiment of the disclosed subject matter.

### DETAILED DESCRIPTION

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

Disclosed herein is a compact pressurized air supply (CPAS) that provides specially pressurized air to a rack-mounted air distribution system for ventilation and de-stratification.

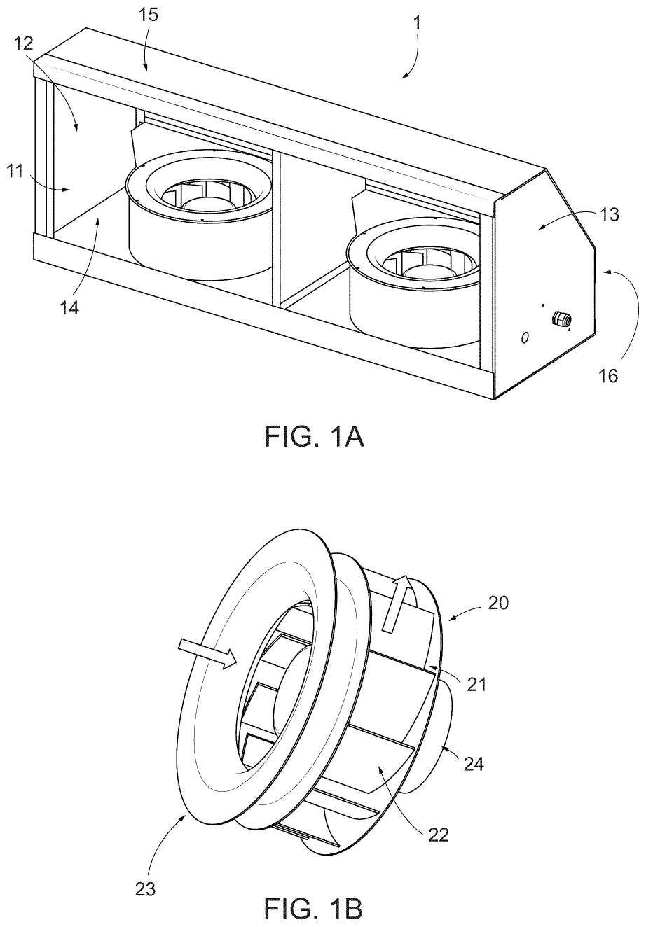

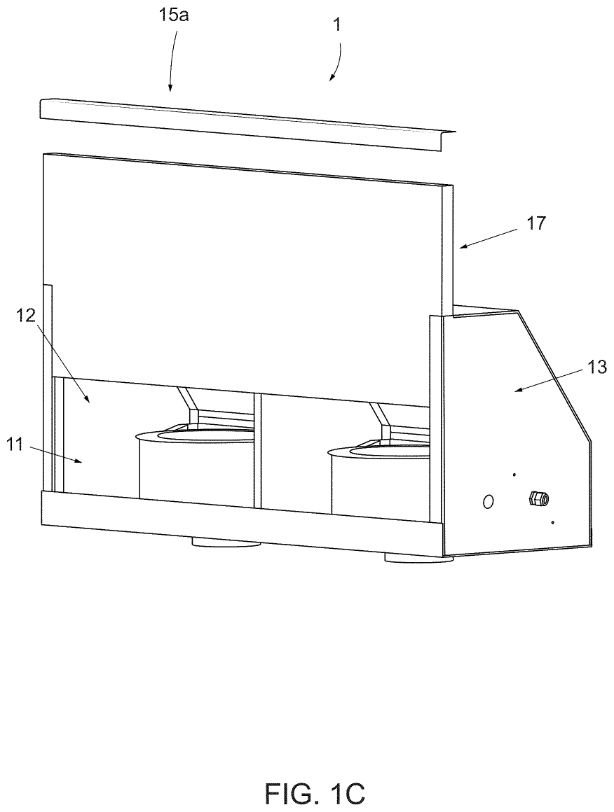

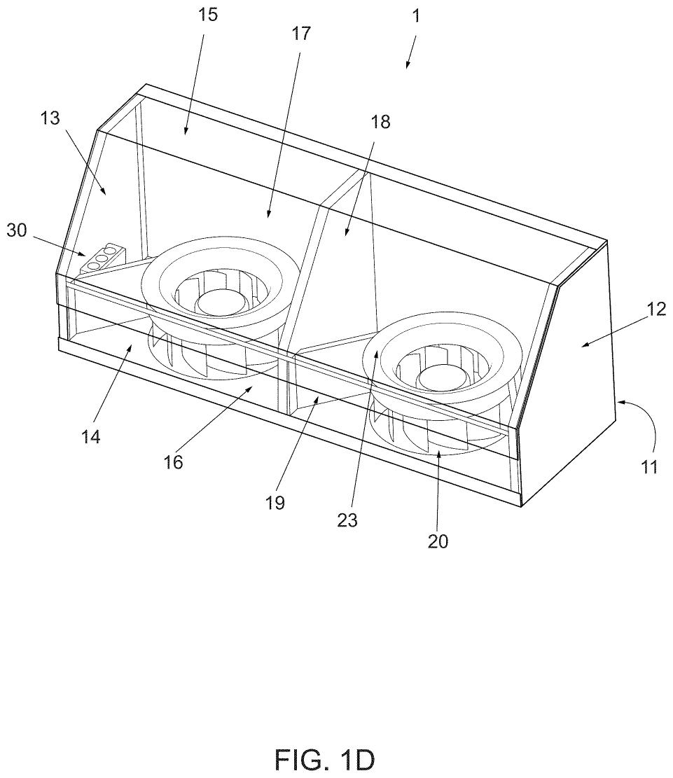

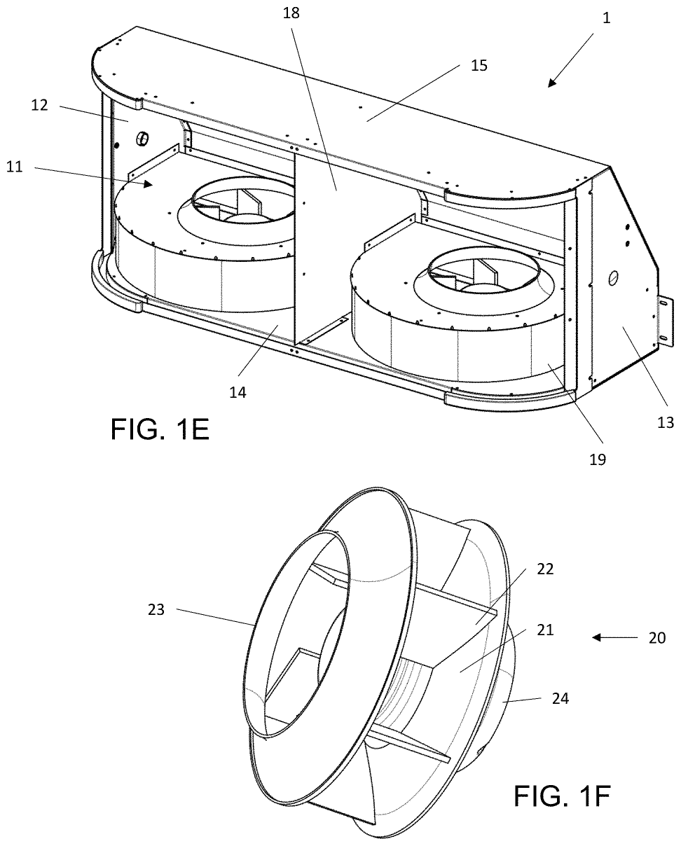

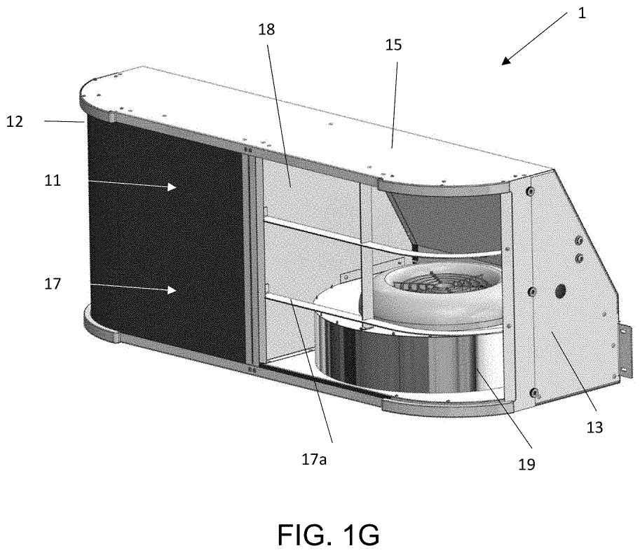

FIG. 1A shows a schematic perspective view of a CPAS air box, according to an embodiment of the disclosed subject matter. The air box 1 comprises a first end 11 with an inlet opening, first and second sides 12 and 13, bottom face 14 and top face 15. In embodiments, the shape of the air box is not limited as long as it is configured such that the inlet of the air box is larger in area than the outlet of the air box as discussed below. In the embodiment shown, the top face comprises a first horizontal portion and a second sloping portion that intersects with the second end 16, but this is not limiting. Other embodiments may include the top face being curved to transition smoothly from the horizontal portion to the sloping portion. Similarly, the sides and front face may be constructed as planar surfaces, or their junction may be curved so that the front opening curves around to a portion of the sides to provide a larger inlet opening. Opposite the first end 11 is a second end 16 with an outlet opening. Sides 12 and 13, bottom face 14 and top face 15 define boundaries of an air passage extending from the inlet opening in the first end of the air box to the outlet opening in the second end of the air box. Disposed in the air passage is one or more centrifugal fans 20 (shown in close-up view in FIG. 1B) mounted on the bottom face 14. Two centrifugal fans are in the embodiment shown in FIG. 1A, but that is not limiting. In the non-limiting embodiment depicted in FIG. 1A, the CPAS has an overall shape wherein the inlet opening has a greater area than the outlet opening. The inlet opening may be generally rectangular, with a horizontal dimension greater than a vertical dimension. As can be seen, the inlet opening comprises substantially (greater than 90%) of the first end of the air box surrounded by a frame defined by the edges of the sides, bottom and top of the air box. In the embodiment shown, the outlet opening has a horizontal dimension greater than a vertical dimension. The first end of the air box has a vertical dimension greater than a vertical dimension of the second end of the air box. These aspects are not limiting. In the CPAS, ambient air enters the inlet opening in a generally horizontal direction and air exits the outlet opening in a generally horizontal direction.

FIG. 1B shows a centrifugal fan useful in the CPAS embodiment of FIG. 1A. For ease of presentation, housing or shroud 19 around the fan is not shown. The centrifugal fan 20 comprises a drum-shaped body 21 with an open interior in fluid communication with a plurality of openings between a plurality of impeller vanes 22. The impeller vanes may be straight radial vanes, or curved vanes that can be backward-curved or forward-curved in relation to the direction of rotation of the drum body 21. Notably, the fan(s) may comprise backward-curved vanes. Impeller intake bell 24 defines an axial opening in fluid communication with the interior of the drum body 21. Air is drawn in through the center of the impeller intake bell 23 and expelled out the plurality of openings, as shown by the arrows, directly into the outlet opening in the second end of the air passage. In the embodiment of the CPAS 1 shown in FIG. 1A, the centrifugal fans have a vertical axis of rotation. An electric motor 24 turns the fan with a sufficient RPM to compress ambient air entering the inlet of the air box and drive it out of the outlet at increased pressure and velocity compared to the ambient air.

In embodiments with two or more centrifugal fans 20, the fans may rotate in the same direction (both clockwise or both counterclockwise) or in opposite directions (one clockwise and one counterclockwise). Counter-rotating fans may be notable to direct air flow toward the center of the outlet of the air box.

The CPAS housing also integrates a removable intake filter located parallel to the housing inlet. The placement of this filter allows for a large surface area and a decrease in accumulating debris. FIG. 1C shows the CPAS 1 with a filter 17 partially installed proximate to the first end 11. Flanges on the sides 12, 13 and bottom 14 may define slots that a panel filter 17 can be slid into from above to cover the inlet opening in the first end 11 of the air box. Retainer strip 15a holds the top end of the filter in place and may optionally held in place by mechanical fasteners such as screws, thumb screws, wing screws, clips, etc., or by magnet coupling(s). A filter panel 17 is shown proximate to the first end 11. Filter 17 is substantially the same size as the inlet opening so that ambient air entering the inlet is filtered. The filter may be constructed of a washable foam or HEPA medium and is designed to remove particulates in the intake air stream. Alternatively or additively, a disposable filter may be used.

FIG. 1D shows the CPAS air box 1 of FIG. 1A from the opposite side. Top face 13 is shown as transparent to allow visualization of the interior of the CPAS air box 1. Outlet opening in the second end is 16 defined by the edges of sides 12, 13, bottom face 14 and top face 15. Comparison of the outlet opening in second end 16 to the inlet opening in the first end 11 shows that the inlet opening has a larger area than the outlet opening.

Optional vertical divider 18 may provide strength and/or rigidity to the air box. It may also help direct air from the inlet into one or the other of the two centrifugal fans 20 shown in this embodiment. Internal shroud 19 wraps around the fan 20 to block air from exiting the fan toward the inlet and direct it toward the outlet opening in second end 16.

The housing may include one or more integrated electrical junction boxes 30, which can serve as connection points to external motor supply wiring, as well as low voltage speed control signals. The housing may also include wired or wireless networking capability to connect to sensor or control networks. Information such as fan speed, outlet pressure, inlet pressure, fan temperature, intake air temperature, intake air humidity, etc. may be transmitted on the network.

FIGS. 1E, 1F and 1G show another embodiment of the ventilation system in which the top 15 and bottom 14 have curved front edges so that front face 11 curves into the sides 12 and 13 of the air box housing. This provides for a greater opening for the air inlet. It also reduces the volume of the airbox that intrudes into the area around a growing rack and the curved surfaces improve safety of personnel working around the air box by eliminating hard sharp edges of the air box. The view in FIG. 1E also shows divider 18 and shrouds 19 inside the air box. FIG. 1F shows another embodiment of the centrifugal fan shown in Fig. B. FIG. 1G shows the airbox with a flexible filter 17 disposed over a portion of front face 11 and wrapping around onto side 12. Another filter 17 is deleted to show a lightweight flexible frame 17a that extends across front face 11 from its junction with divider 18 to its junction with side 13. The bottom of the framework may be supported by the shroud 19. A similar framework extending from divider 18 to a junction with side 12 is not visible behind filter 17.

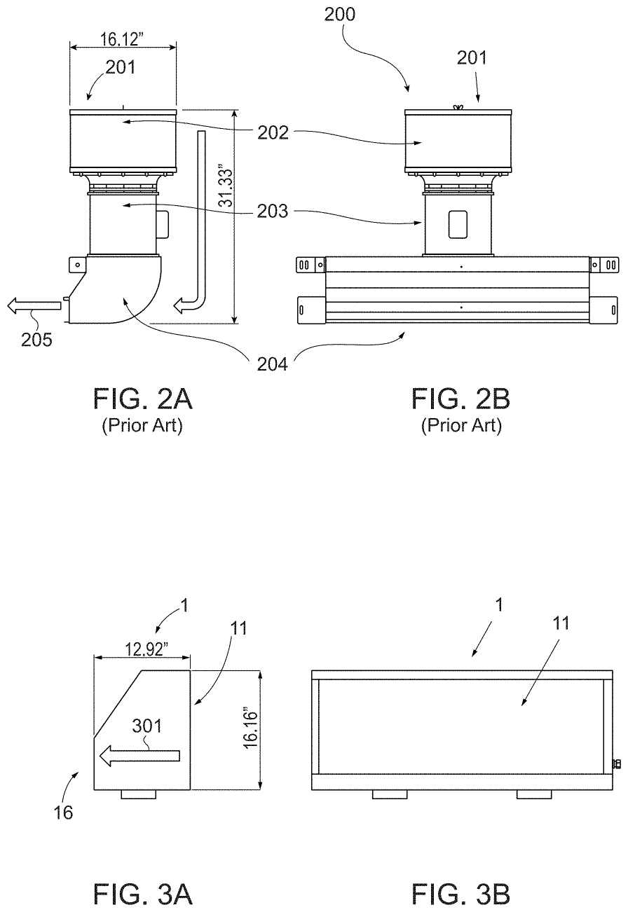

FIGS. 2A and 2B show side and front views of a conventional prior art ventilation system for a vertical growing system, respectively. As seen in FIG. 2A, conventional solutions use a combination of externally mounted fans, filters and ductwork to direct air into a rack-mounted ventilation and de-stratification system. These systems 200 include an air box or housing 204, an externally mounted fan 203 (depending on the location of the filter) and/or a filter 202 located either before or after the fan. The fan is typically an axial tube fan (“can fan”) that is mounted vertically on an air box. The air box is then coupled to the ventilation ductwork that extends horizontally along the growing rack. The primary function of the air box 204 is to turn the airflow, which is supplied in an upward or downward direction, to match the horizontal input of the rack mounted ductwork. In the example 200 shown, air enters the top of the system at arrow 201 and is turned by the air box to a horizontal direction, as indicated by the arrow to exit the ventilation system at arrow 205.

In some designs the filter is located in a filter housing, which also serves to turn the air from the input to output. In these designs the fan is located externally to the housing, which contains a filter or series of filters. Air is directed into the housing by the externally mounted fan, which may or may not include a pre-filter. The primary drawback to all of these external fan designs is the need to immediately turn the airflow exiting the fan up to 90 degrees in a very tight space. This turn is necessitated by the tight clearance usually found on the back of CEA racks, which would not allow a large air box or inline axial fan. This tight turn leads to significant pressure losses and unnecessary turbulence in the ductwork. The pressure loss is exacerbated in designs incorporating a compact filter housing directly after the fan, as it is very difficult to provide sufficient filter media area. This leads to very high velocities through the filter, high pressure drop and frequent loading of the filter.

FIGS. 3A and 3B shows side and front views of a CPAS ventilation system as described herein. The CPAS design addresses the issues of prior art conventional ventilation systems by integrating specially designed fans directly into the air box. By incorporating specific fan designs that have an inherent 90 degree direction change input to output, the air box or housing no longer needs to perform this function. Centrifugal impellers integrated into the air passage inside the air box eliminate the need for a turning duct to change the direction of the air exiting a conventional can fan (axial fan). This leads to a much more compact and efficient design. Air is drawn into the housing at the inlet opening in face 11 parallel to the output in face 16, and no direction change occurs relative to the housing intake as air exits the fans (arrow 301). Comparing FIGS. 2A-2B with FIGS. 3A-3B, a CPAS configured to deliver the same amount of air to a duct in fluid communication with the outlet as a conventional system is more compact and simpler in construction. It is notable that the housing is under vacuum in the CPAS design, versus being under pressure for all conventional systems.

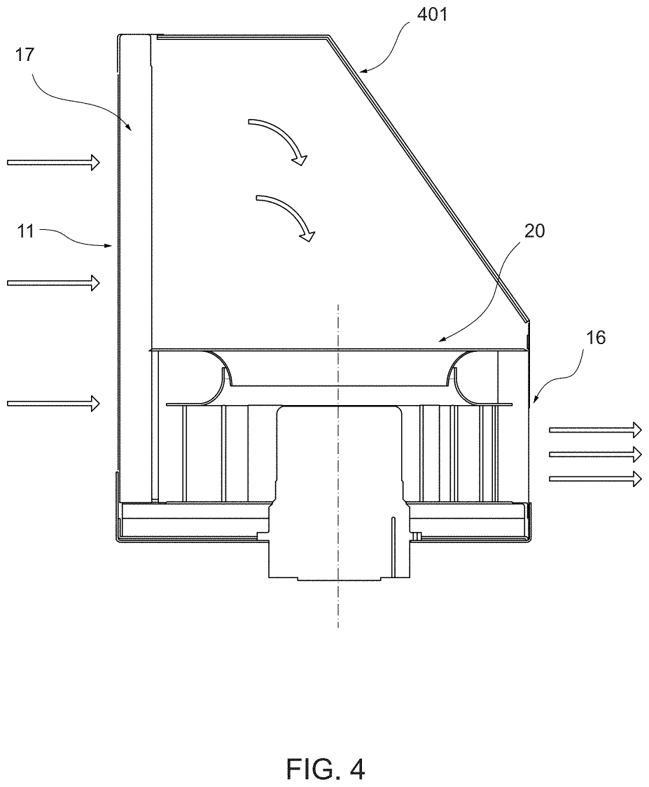

In the embodiments shown in FIGS. 1A-1D, shown in schematic cross-section in FIG. 4, centrifugal impeller(s) 20 are used in which the axis of rotation is perpendicular to the horizontal plane of rack-mounted ducting. In this design, the rack-mounted ducting lies along a hypothetical X-Y plane, with the X axis lying along the length of the duct and the Y axis along the width, with airflow in the X direction. The impeller rotation is around the Z-axis. Air is drawn horizontally into CPAS housing 401 through the opening in front face 11, through filter 17 and vertically into the impeller along the Z axis and then exits tangentially through the outlet in a second end 16 into the ductwork (not shown), achieving the required direction change and increase in pressure without the need for additional bulky turning features in the air box.

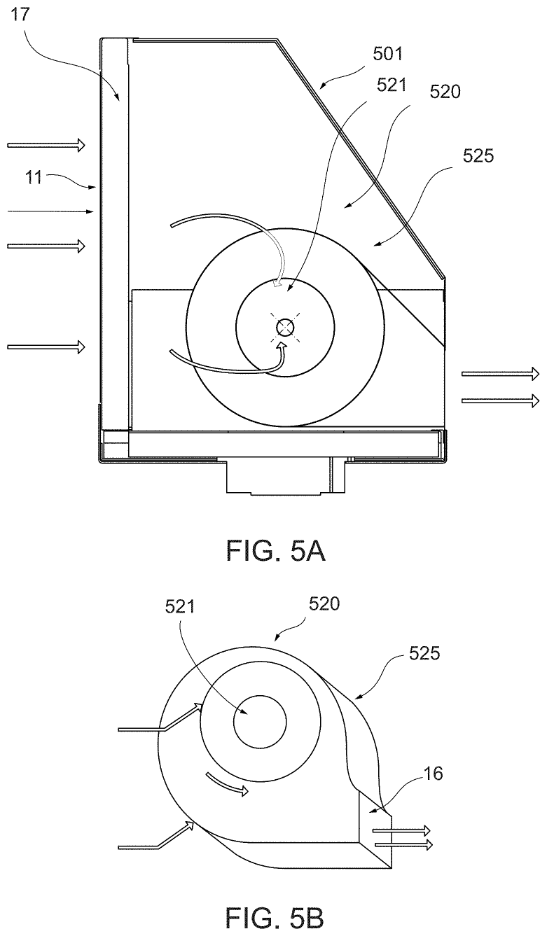

In other embodiments, the centrifugal fan may alternatively rotate about the Y-axis, drawing air into the fan along the same Y-axis and discharging it along the X axis into the duct. In an embodiment, shown in schematic cross-section in FIG. 5A, this may comprise a centrifugal blower design 520 with a scroll or volute housing 525. A representative volute casing is shown in FIG. 5B. Air enters the air box 501 horizontally along the X-axis at 11, passes through filter 17 and makes a horizontal turn into intake 521 to the center of the impeller (not shown) rotating about the Y-axis and exits the casing 525 in the X-direction at 16. In this embodiment components of the device may be similar to those described for the embodiment described in FIGS. 1A-1D, except for the configuration of the fan inside the air box. In this embodiment, one, two or more housed fan may be configured in the air box, depending on the desired dimensions of the system.

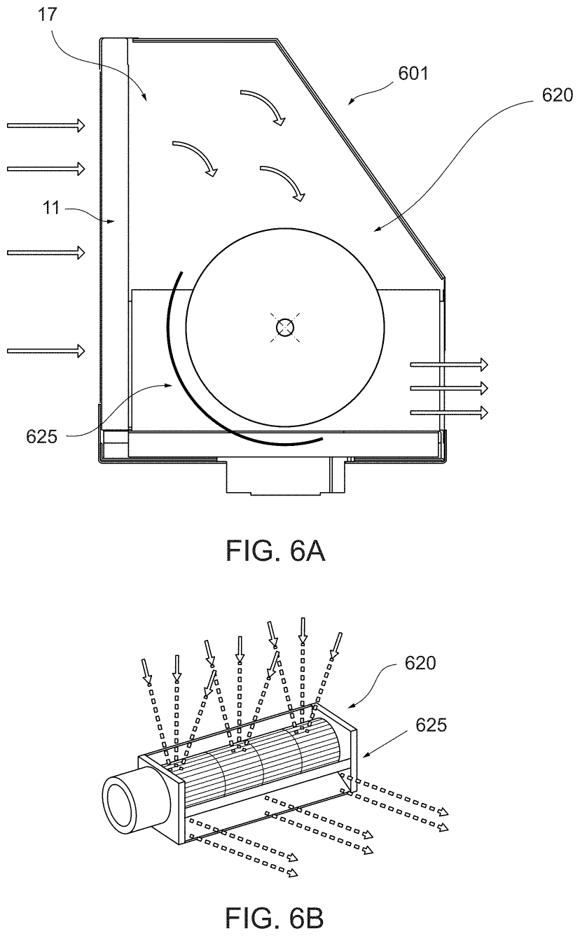

Another embodiment uses a tangential or crossflow type fan, where the fan is again rotating about the Y-axis, but in this case air would be drawn into the impeller along the Z axis as in the first design. The impeller in this case would extend along the width of the outlet, providing consistent flow along the width of the duct. In an embodiment, shown in schematic cross-section in FIG. 6A, this may comprise a tangential or cross flow fan 620 with a shroud 625. A representative cross flow fan is shown in FIG. 6B. Air enters the air box 601 horizontally along the X-axis at 11, passes through filter 17 and enters the fan 620 through the open top of shroud 625 to the impeller rotating about the Y-axis and exits the shroud 625 tangentially in the X-direction at 15. In this embodiment, components of the device may be similar to those described for the embodiment described in FIGS. 1A-1D, except for the configuration of the fan inside the air box.

The housing of any embodiment described herein may also be capable of including a component to amend air before it exits the air passage such as a heater, cooler, dehumidifier, humidifier, carbon dioxide (CO₂) injector, ozone injector, ultraviolet light emitter, or combinations thereof. Notably, the system may include UV antimicrobial lighting on the intake side, which benefits from the lower flow velocities present in the housing. Lower flow velocities increase the time of UV exposure and increase the effectiveness of such a system.

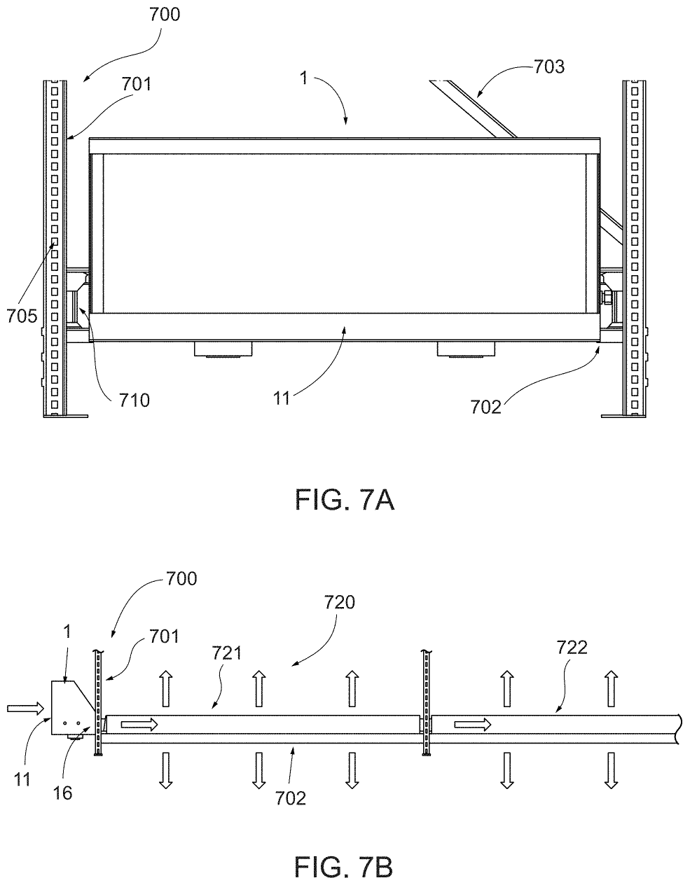

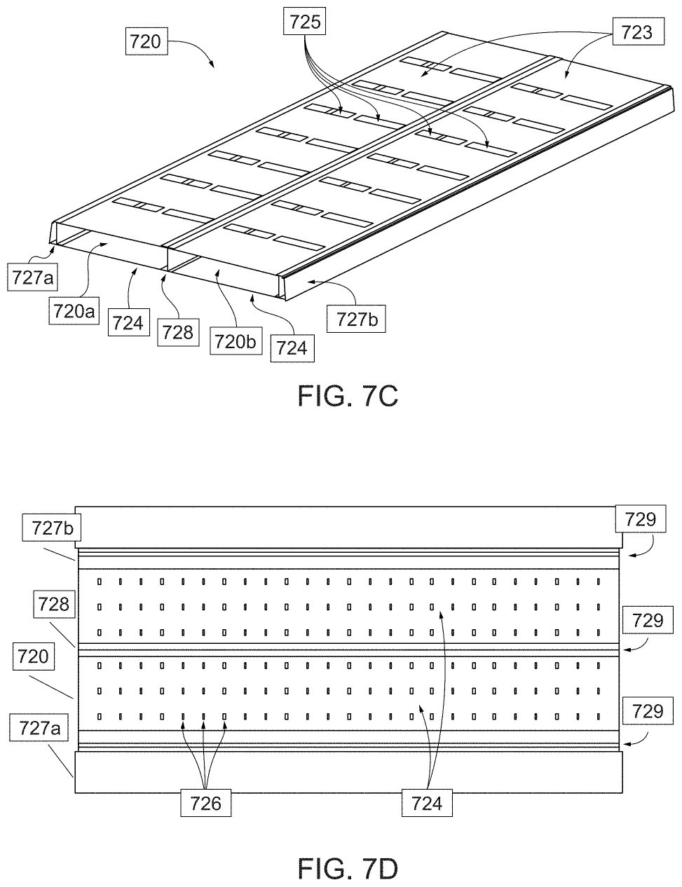

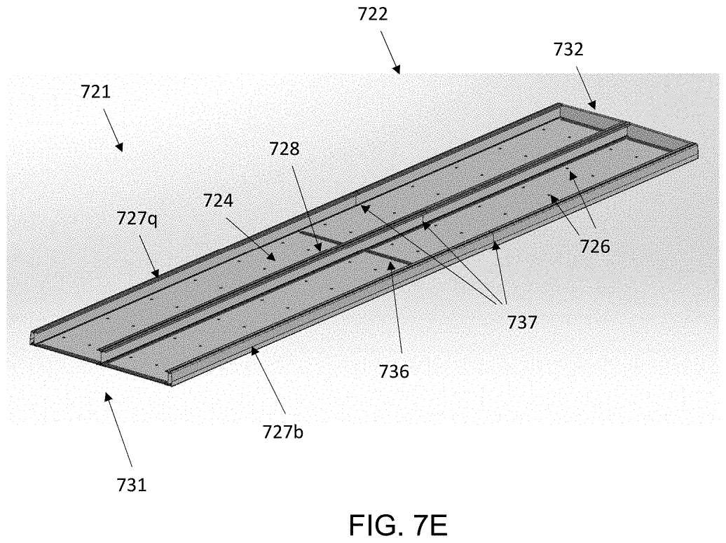

The housing is designed to be used in conjunction with a racking system and fluidly coupled to rack mounted distribution ducting. FIG. 7A shows the front of the CPAS mounted on a racking system 700 comprising upright members 701, shelving members 702 and diagonal braces 703. Upright members preferably comprise a plurality of holes or openings 705 that allow components to be mounted thereon, using fasteners such as bolts or clips. The plurality of holes 705 allows a user to selectively position shelves 702 and the CPAS 1 at desirable levels or heights to grow plants in a vertical growing system. The racking system may comprise a plurality of shelving members 702. Brackets 710 on each side of the CPAS housing allow for its attachment to the racking system. FIG. 7B shows a side view of the CPAS 1 attached to the rack 700 and a duct system 720 that is in fluid communication with the outlet of the CPAS. The duct system comprises one or more elongate duct members (two are shown: 721 and 722). As shown by the arrows, ambient air at the left of the figure is drawn into the inlet 11 of the CPAS, pressurized and then driven out the outlet 16 into the duct system. Each duct member may comprise a plurality of orifices (not shown) that distributes air from the duct above and/or below the duct to plants (not shown) supported by the growing system.

In an embodiment, the CPAS outlet opening is in fluid communication with an elongated duct assembly comprising one or more air passages, the duct assembly having a first end in fluid communication with the outlet opening, a second end opposed to the first end configured to be either closed or in fluid communication with a second duct assembly member, and a plurality of orifices in the one or more air passages to distribute air out of the one or more air passages. Notably, the duct system comprises a plurality of orifices configured to direct air from the duct assembly to above the duct assembly; or direct air from the duct assembly to below the duct assembly; or direct air from the duct assembly to above and below the duct assembly.

FIG. 7C shows a top perspective view of an exemplary embodiment of a duct assembly. In the embodiment shown in FIG. 7C, a representative duct assembly 720 is constructed of flat top panels 723 that form the top of the duct assembly 720, flat bottom panels 724 that form the bottom of the duct assembly 720, a center support member 26 and side support members 27a and 27b. Flat panels 723 and 724 may be made from polymer, composite or metal. Preferably the duct assembly panels can be made of plastics such as PVC, ABS, ASA, polycarbonate, polyethylene, etc. Notably, expanded PVC can be used due to its low cost and stiffness. FIG. 7C shows that the top panels 723 may optionally comprise holes 725 to provide air flow above the duct. In embodiments, the holes are configured to be in fluid communication with holes in a tray described further below. In other embodiments (not shown), the top panels 723 do not have holes and air would not be delivered above the duct.

As shown in FIG. 7D, in some embodiments the bottoms of the ducts 720a and 720b may comprise a plurality of orifices 726 in the bottom panels 724 to allow air to be distributed from the CPAS ventilation system through the ducts and onto plants below the tray system in a vertical growing system. The orifices may be round, oval shaped, rectangular, slotted etc. In other embodiments the bottom panels 724 do not comprise orifices 726 and air cannot exit from the bottom of ducts 720a and 720b. The distribution of orifices 726 in bottom panels 724 may be based on the desired flow capacity of the blowing system.

In the embodiment illustrated in the Figures, the edges of the top and bottom duct panels 723 and 724 are attached to the center support member 728 and side support members 727a and 727b preferably by insertion into slots at the top and bottom of the center and side support members. To provide adequate support for a tray placed over the duct (see below) and plant containers thereon, the support members may be typically fabricated from a variety of materials such as stainless steel, aluminum, alloys or carbon composites, etc. Notably, the support members are configured to be elongate with a consistent cross-section along their length, allowing for their fabrication as extrusions. Preferably, the center and side support members are aluminum extrusions.

The top panels 723 and bottom panels 724 are preferably releasably engaged with the support members 728, 727a and 727b so that the duct assembly can be disassembled to interchange top panels 723 and/or bottom panels 724 to modify the air distribution out of the ducts 720a and 720b to direct air above the tray system, below the tray system or both above and below the tray system. Disassembly also allows for easy cleaning and/or compact storage of the components of the duct assembly 720.

Optionally, as shown in FIG. 7D, the support members 728, 727a and 727b may also incorporate a feature (in the embodiments shown a “t-slot”) 729 along their bottom surfaces to allow the installation of hooks or fittings to hold lighting and/or other equipment. Embodiments include those wherein the central support member 728 comprises a t-slot extending the length of the central support member. Embodiments include those wherein the first and second elongate side support members 727a and 727b each comprises a t-slot extending the length of their respective bottoms. The t-slots 729 can also serve as a fastening feature between duct sections with the use of a connector that fits within the slot and bears between the inside of the slot and the top on each support member section. The t-slots 729 may also be used to attach the duct assembly 20 to horizontal support members (e.g. shelf 702) on a rack system 700.

FIG. 7E shows duct members 721 and 722 abutted end-to-end, with top panels 723 removed. This Figure shows the duct assembly with a first open end 731 configured to engage with the outlet end of a CPAS described above to receive pressurized air into the duct. The second end 732 is shown as closed so that air has to exit the duct via openings 726 in bottom panels 724. In this view, joints 736 between bottom panels 724 and joints 737 between support members are shown as staggered, which may provide additional stability to duct assembly that comprises two or more duct members 720.

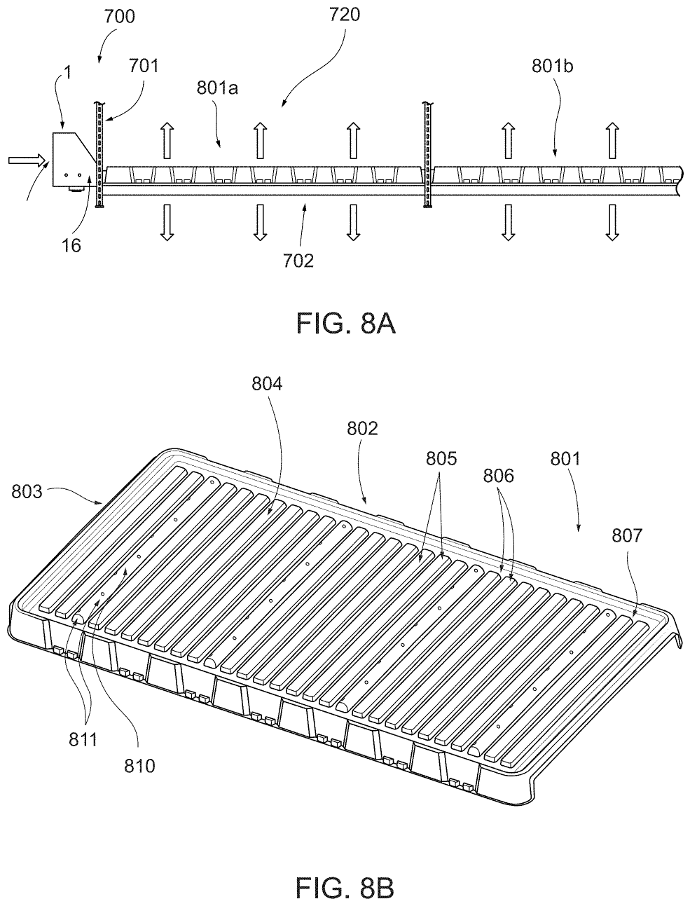

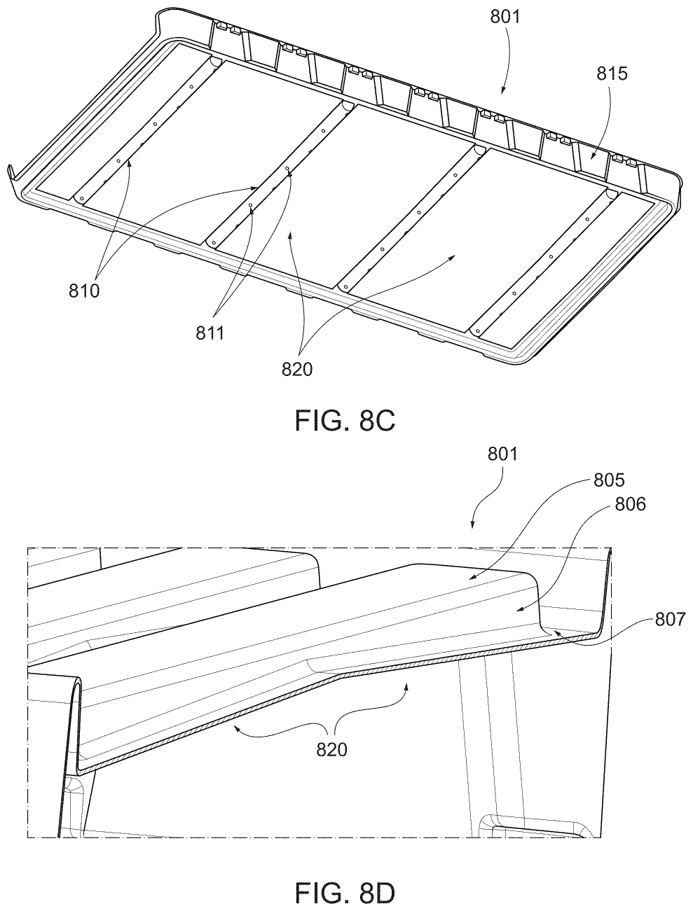

In embodiments, the system may further comprises one or more trays to support plants and growing medium above the ducts. FIG. 8A shows two trays 801a and 801b disposed over the duct members 721 and 722 (not shown, see FIG. 7B). As described above, openings 726 (when present) in the bottom of the duct assembly allow fresh air to exit the duct out the bottom to provide air to the top of the leaf canopy of plants below the duct assembly. Openings 725 (when present) in top panels align with ridges 810 to allow air to exit from the top of the duct assembly into ridges 810 and out holes 811 (see FIG. 8B) to provide fresh air below the leaf canopy of plants disposed on the trays.

A top perspective view of an embodiment of a representative tray 801 is shown in FIG. 8B. The tray comprises opposed side walls 802 and opposed ends 803 defining a perimeter of the tray, and a raised region 804 disposed within the perimeter of the tray. In embodiments, the side walls 802 of the tray may extend below the raised region to support the raised region above the duct assembly. The side walls may also provide support to the tray when it is not disposed on the duct assembly. Preferably, the raised region of the tray comprises a plurality of alternating parallel ridges 805 disposed between the side walls and a plurality of valleys 806 formed between adjacent ridges of the plurality of ridges, wherein one or more of the plurality of valleys are in fluid communication with a gutter 807; and optionally one or more of a plurality of holes 811 in one or more of the plurality of ridges. In the embodiment shown, a subset of the ridges comprises a plurality of ridges 810 that comprise holes 811. In preferred embodiments, the ridges 810 have top surfaces higher than the top surfaces of the ridges 805 to prevent water from above to pass through the holes 811. The plurality of holes 811, when present, are in fluid communication with the plurality of orifices in the top panel(s) 724 of the duct assembly 720 to direct air from the duct assembly to above the tray 801.

In the embodiment shown, the plurality of alternating parallel ridges 805 comprise top surfaces defining a level plane for supporting one or more individual growing containers for containing growth medium and plants, and the plurality of valleys slope downward from a peak to the gutter proximate to the perimeter of the tray, the one or more of the plurality of valleys are in fluid communication with the gutter for channeling fluid collected into the gutter. Notably, the gutter may be configured to be in fluid communication with a fluid drainage system.

Typically, the ducting 720 will be laid down first with the tray 801 positioned or disposed over the top of the duct 720. The duct assembly 720 is designed to nest under the tray 801, which preferably has sloping valleys 806. In these embodiments, the upper surfaces of the duct assembly 720 may be angled to accommodate the draining feature of valleys 806 of the tray 801, which are sloped to collect and concentrate the excess water and nutrients. Accordingly, in the embodiment of the duct 720 shown in FIG. 7C, the cross-section of the two ducts 720a and 720b of the duct assembly 720 may generally be trapezoidal with a flat bottom and sides and an angled top.

In some embodiments, the bottom surface of the raised region of the tray comprises the top panel of the duct assembly. In an embodiment shown in FIG. 8C, the underside of a tray 801 is shown. Fitting 815, such as a hose barb, is disposed on the bottom of the tray to allow fluid communication from the gutter to a drainage system via a hose or tubing (not shown) attached to the fitting 815. Optionally, thin adhesive backed panels 820 can be added to the underside of the tray to improve performance by reducing duct turbulence inside the duct. The panels 820 may be adhesively attached to the bottom surface of the valleys in the raised portion of the tray. It can be seen that panels 820 may cover a significant part of the underside of the tray. Notably, the panels 820 do not cover the bottom of the ridges 810, allowing air to pass from the duct into the ridges 810 and out holes 911 in tray 801. In other embodiments not shown, the panels 820 cover the bottom of the ridges 810, preventing air from passing from the duct into the ridges 810 and out holes 911 in tray 801.

FIG. 8D shows a perspective view of a cutaway of tray 801, showing the relative geometry among the ridges 805, valleys 806 and gutter 807. The valleys 806 slope toward the gutter 807 so that water on the raised region of the tray flows to the gutter. Panels 820 are attached to the bottom of the valleys.

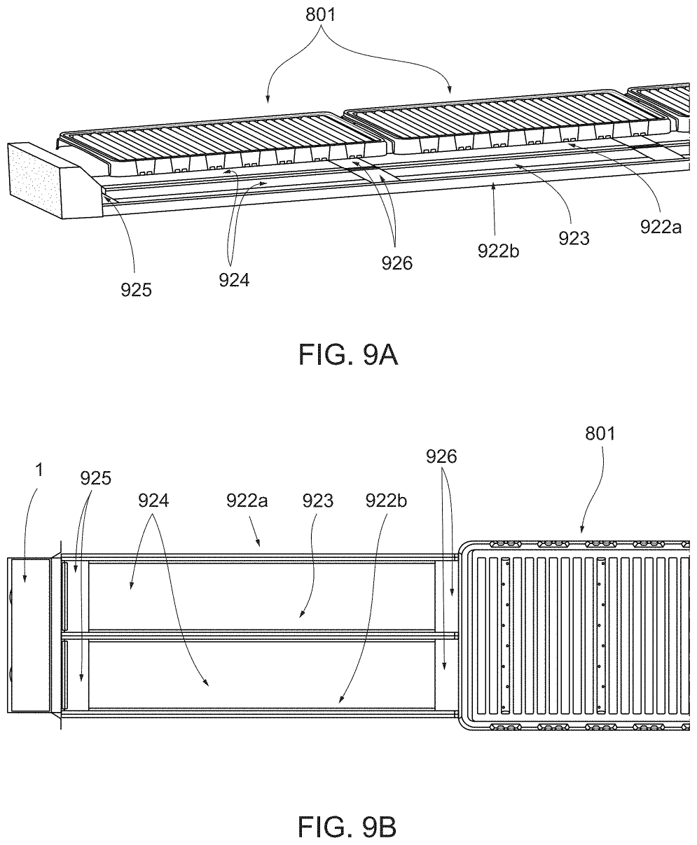

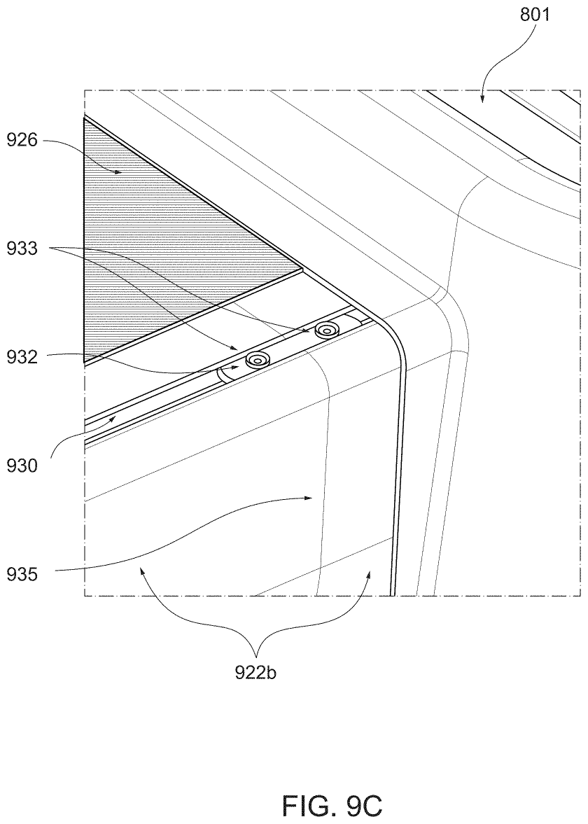

FIG. 9A shows an exploded perspective view of an embodiment of the ventilation system using trays 801 wherein their bottom surfaces comprise the top panels of the duct system 920. FIG. 9B shows a top view of an embodiment of the ventilation system wherein one tray 801 is removed to show the bottom of the duct system 920. Because the trays 801 comprise the top of the duct system 920, the bottom of the duct system 920 can be configured as a trough, comprising side members 922a and 922b and bottom panels 924. Optionally, as shown in this embodiment, a center member 923 may be included. Bottom panels 924 are disposed between the center member 923 (if present) and respective side members 922a and 922b. Bottom panels 924 may optionally comprise a plurality of openings similar to openings 724 shown in FIG. 7D to distribute air below the duct. The bottoms of the side and center members 922a, 922b and/or 923 may comprise a t-slot similar to t-slot 729 along the bottom surface to provide for the installation of hooks or fittings to hold lighting and/or other equipment, a fastening feature between duct sections, and/or to attach the duct assembly 920 to horizontal support members (e.g. shelf 702) on a rack system 700. Small panels 925 are configured to be disposed at the tops of the center member 922a, 922b and/or 923 to provide an enclosed duct segment in fluid communication with the outlet of the CPAS unit 1. Additional small panels 926 are configured to be disposed at the tops of the side and center member 922a, 922b and/or 923 to provide an enclosed duct segment between the ends of the trays 801. Panels 925 and 926 may be configured to rest on, and optionally attach to, the tops of the tops of the side and center members 922a, 922b and/or 923. Alternatively, Panels 925 and 926 may be configured to engage slots or recesses in the side and center members 922a, 922b and/or 923.

FIG. 9C shows a detail of the embodiment shown in FIGS. 9A and 9B. Tray 801 is disposed above side members 922b. Two side members 922b are joined by a connector plate 932 disposed in a groove 930 in the top of the side members 922b. Plate 932 is fastened to the side members 922b with screws 933. Panel 926 is engaged proximate to the top of the side panels 922b so that it overlaps the seam 935 between the side members 922b, thereby forming an enclosed duct portion below adjacent trays 801. An elastomeric gasket or weatherstrip (not shown) may be disposed in the groove 930 to provide an air-tight junction between the top of side member 922b and the bottom of tray 801 to provide an enclosed duct.

In embodiments, side members 922a, 922b and center member 923, when present, are strong enough to support trays and plants thereon without using a continuous shelf 702 in a vertical rack system 700. Optionally, horizontal cross members between vertical members of the rack system can be used to support the duct system.

In additional embodiments of a compact pressurized air supply (CPAS), the impeller is integrated within the duct assembly. In these embodiments, the inlet portion of the air box, the first end of the air passage, is mounted below the duct and the impeller of a centrifugal fan extends into the first end of the duct member. The outlet of the air box, the second end of the air passage, is contained within the first end of the duct member. Air enters the inlet horizontally, and is driven down the duct horizontally toward the second end of the duct member by the centrifugal fan. These embodiments are very compact and require little to no end clearance for a ventilation system connected to elongated ducts for use in a vertical growing system where there is no clearance for a fan box extending beyond the ends of the tracks.

In these additional embodiments, the ventilation system comprises an air box comprising a first air chamber extending from an inlet opening in a first end of the air box and a second air chamber extending from an outlet opening in a second end of the air box and a centrifugal fan or a tangential fan disposed between the first air chamber and the second air chamber, the fan in fluid connectivity with the first air chamber and the second air chamber to define an air passage configured to move air from the first end to the second end of the air box.

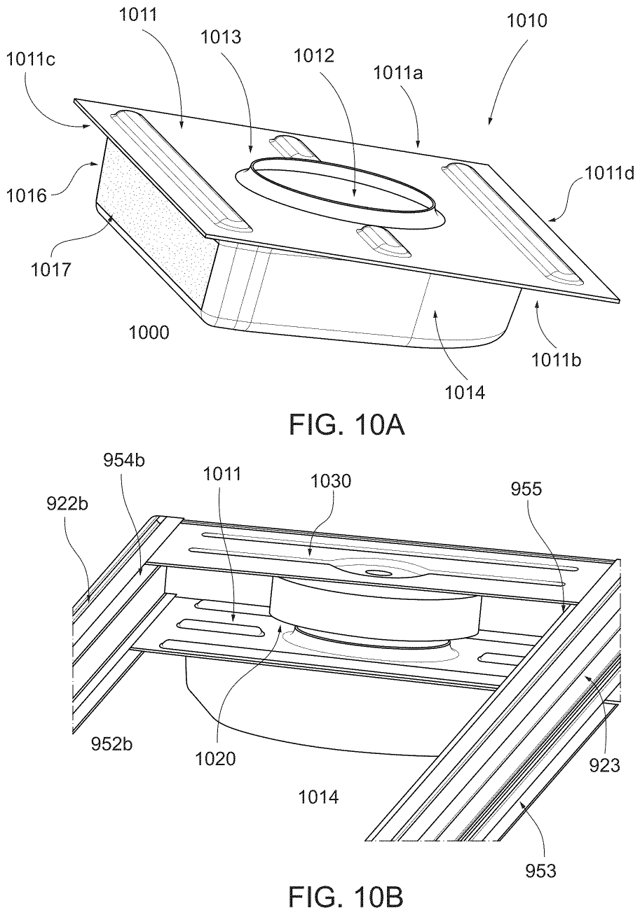

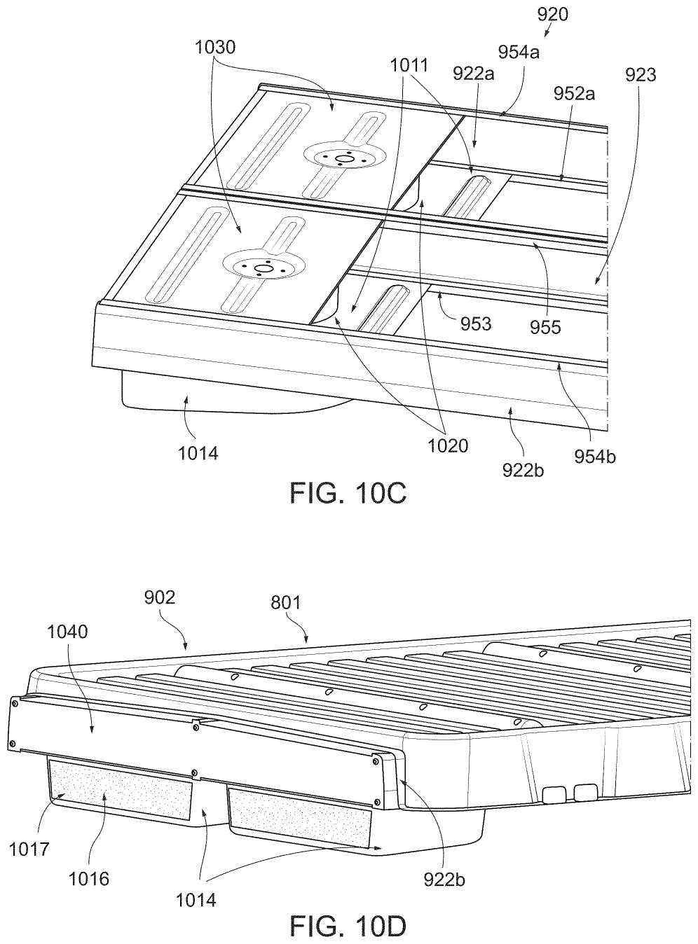

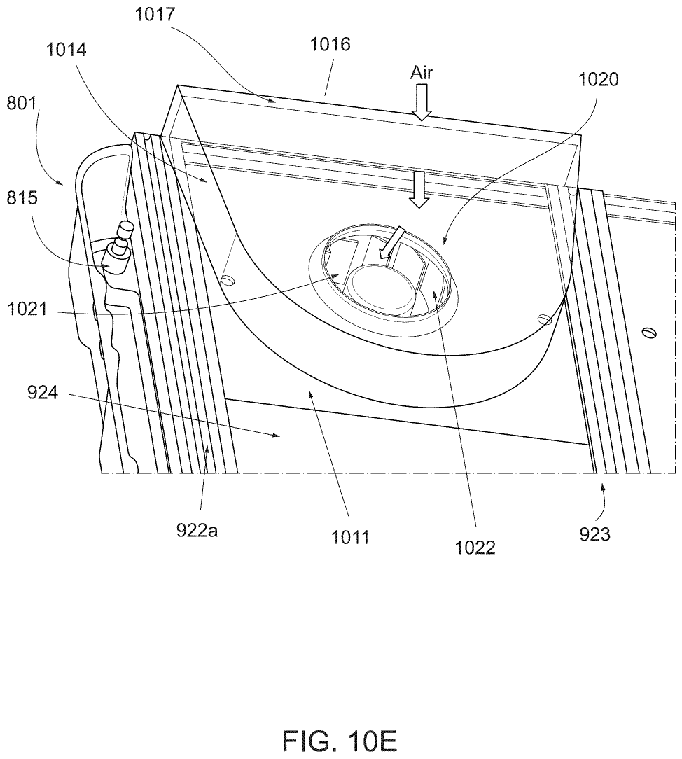

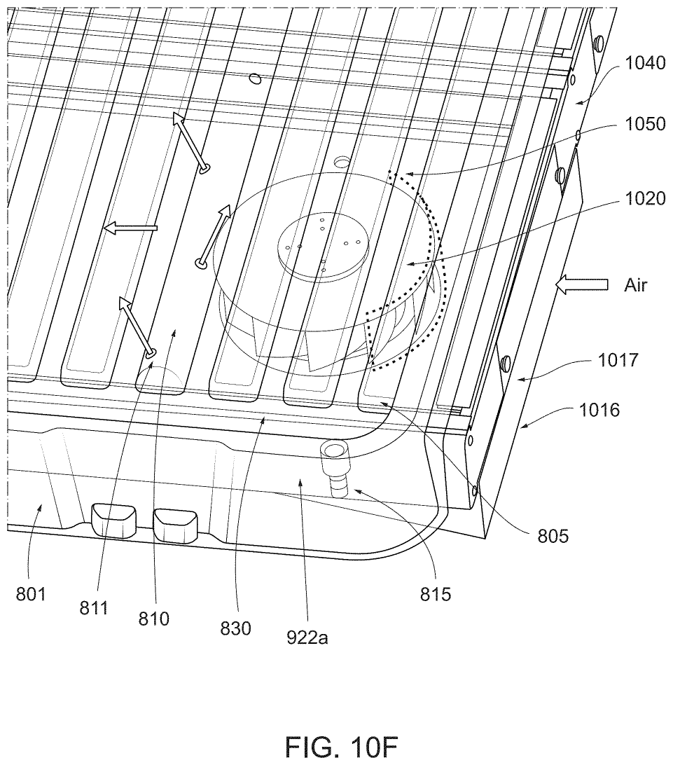

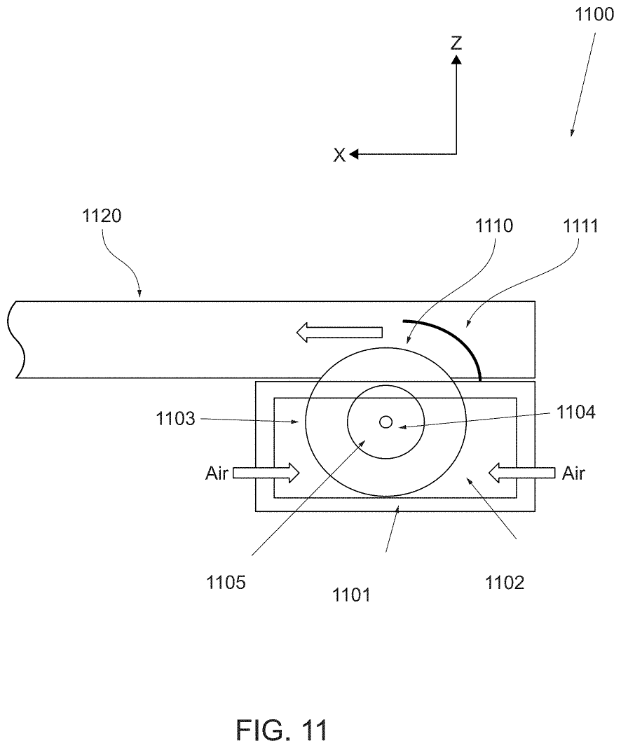

FIGS. 10A-F show aspects of an embodiment of a CPAS system 1000 with the fan integrated into the duct assembly. FIG. 10A shows an intake housing 1010 for this embodiment. The housing 1010 comprises a plate 1011 with an opening 1012 defined by a raised rim 1013. The opening 1012 and rim 1013 are configured to engage the inlet of a centrifugal fan (not shown, see FIG. 10B) so that the opening 1012 is in fluid communication with the interior of the centrifugal fan. The housing 1010 defines a first air chamber in this embodiment. Edges 1011a and 1011b of plate 1011 are configured to engage shelves and/or slots in side members 922a or 922b and center member 923 of a duct system 920 (not shown, see FIG. 10B). Other edges 1011c and 1011d are also shown. A scoop-shaped shroud 1014 is disposed below plate 1011 to define a cavity or first air chamber inside the housing 1010. Shroud 1014 comprises opening 1016 to provide an air inlet into the housing 1010. Filter 1017 disposed in the opening 1016 provides for removal of particulates from the ambient air entering the cavity through the opening 1016. Plate 1011 and shroud 1014 define the boundaries of an air passage from opening 1016 to opening 1012, comprising the first end of the air box as described herein.

The second end or second air chamber of the air box of CPAS 1000 is shown in FIG. 10B in perspective view. Plate 1011 is engaged to lower shelf 952b on side member 922b and a lower shelf 953 on center member 923. Thus plate 1011 serves as a bottom panel for the duct assembly in the region of the air passage. Centrifugal fan 1020 is disposed above plate 1011 over opening 1012 (not visible in this view) and below top plate 1030. The second air chamber of the second end of the air box is defined by plates 1011 and 1030, side member 922b and center member 923. The open side of the second air chamber provides an outlet of the air box that is directed into and is in fluid communication with the remainder of the duct assembly as described further below.

FIG. 10C shows a perspective view of two air boxes of this embodiment disposed side-by-side in a duct assembly 920. Plates 1011 are engaged to lower shelves 952a and 952b (not visible) on side members 922a and 922b, respectively, and lower shelves 953 on center member 923. Centrifugal fans 1020 are disposed above plate 1011 and below top plates 1030. Two shrouds 1014 (one is not visible) are disposed below the plates 1011.

Not shown in FIGS. 10B and 10C are bottom panels 924 disposed between the center member 923 and either 922a or 922b, that provide the bottom of the duct assembly beyond the air box region.

FIG. 10D shows another perspective view of two air boxes of this embodiment disposed side-by-side in a first end of a duct assembly 920. Two shrouds 1014 are disposed below the duct assembly. Each shroud comprises an inlet 1016 with a filter 1017 disposed therein. Tray 801 is disposed to define the top of the duct assembly. A portion of side member 922b is seen projecting out from under tray 801. Plate 1040 is attached to the ends of the side and center members to close the first end of the duct assembly so that air enters the duct assembly via opening 1016 and is driven through the duct assembly away from the first end.

FIG. 10E shows the embodiment of the CPAS 1000 engaged to the duct and tray system from below. Shroud 1014 is shown as transparent to allow visualization of components within the CPAS. As shown by the arrows, air enters the CPAS via opening 1016, through filter 1017 into the interior of the shroud 1014, where it is drawn into the inlet of centrifugal fan 1020 by the plurality of vanes 1021 rotating about the axis of rotation of the fan 1020. Bottom panel 924 abuts panel 1011 to close the bottom of the duct assembly.

FIG. 10F shows the embodiment of the CPAS from above. Tray 801 is shown as transparent to allow visualization of components within the CPAS. As shown by the arrows, air enters the CPAS horizontally via opening 1016, through filter 1017 into the interior of the shroud 1014, where it drawn into the inlet 1021 of centrifugal fan 1020 by the plurality of vanes 1022 rotating about the axis of rotation of the fan 1020. Pressurized air is driven into the duct by the movement of vanes 1022. A portion the air is driven out of holes 811 in ridge 810, while the majority of pressurized air moves horizontally further down the duct. Gasket 830 is disposed between side member 922a and tray 801. Optionally, an internal shroud 1050 (shown in dashed outline) may be disposed around a portion of the centrifugal fan 1020 to facilitate directing air down the duct.

The embodiment of the CPAS 1000 shown in FIGS. 10A-10F is designed to draw air horizontally into the duct assembly from the end in the X-direction, parallel to the orientation of the duct assembly (end-entry). In alternate embodiments, the CPAS 1000 may be configured to draw air into the duct from the side, the Y-direction. This side-entry configuration can be achieved by turning the shroud 1014 90 degrees relative to that shown in the figures. All other components described remain essentially the same as previously described. For example, if plates 1011 and 1030 are square, instead of engaging edges 1011a and 1011b with the lower shelves 0953 and 952a or 952b on the center and side members, edge 1011c can be engaged to shelf 952a or 952b and edge 1011c can be engaged to shelf 953. Alternatively, shroud 1014 may be configured so it is not attached to plate 1011, but instead comprises an opening coaxial to opening 1012 that is pivotably engaged to the rim 1012 so that it can swivel between an end-entry and a side-entry configuration. Side-entry CPAS units may be useful for pressuring the center of a duct assembly. Because the CPAS 1000 is configured to fit within the footprint of the duct and tray assembly, one or more CPAS 1000 units can be deployed in a single level of a vertical growing rack without extending into the space around the growing rack, impeding movement around the growing rack. For example, in a long duct run, the pressure drops as the air exits the duct above and/or below the duct. Pressure inside the duct can be increased by using an end-entry CPAS at each end of the duct run and one or more side entry CPAS units along the duct run between the duct ends. The small volume of the CPAS unit 1000 allows great flexibility in designing a growing system to accommodate a variety of configurations.

FIG. 11 shows a schematic view of an alternative embodiment 1100 of a CPAS system wherein a portion of the fan extends into the duct assembly and air enters the housing from the side relative to the orientation of the elongated duct, i.e. along the Y-axis. This embodiment is a variation of a volute fan described above in relation to FIGS. 5A and 5B. In this embodiment, housing 1101 is disposed below a duct 1120 and defines a first air chamber. Housing 1101 has an inlet opening 1102 with a filter (not shown) disposed therein to filter ambient air entering the housing 1101 through opening 1102. A centrifugal fan 1103 with its axis of rotation 1104 lying along the Y-axis is disposed near the top of the housing so its lower portion, including its inlet 1105, is within the housing 1101. The upper portion of the air box, including its exit 1110, is disposed within the duct assembly 1120 and defines the second air chamber. Shroud 1111 extends into the duct 1220 from the housing 1101 to direct airflow around the fan 1103 to exit the fan through exit 1110 into duct 1120. In the embodiment shown, a single opening 1102 allows air to be drawn into the center of fan 1103 at one end. In other embodiments, the housing 1101 may have two openings 1102 so that air can be drawn into the center of fan 1103 at both ends. As described above in relation to CPAS unit 1000, the CPAS unit 1100 is configured to fit within the footprint of the duct and tray assembly without extending into the space around the growing rack, impeding movement around the growing rack.

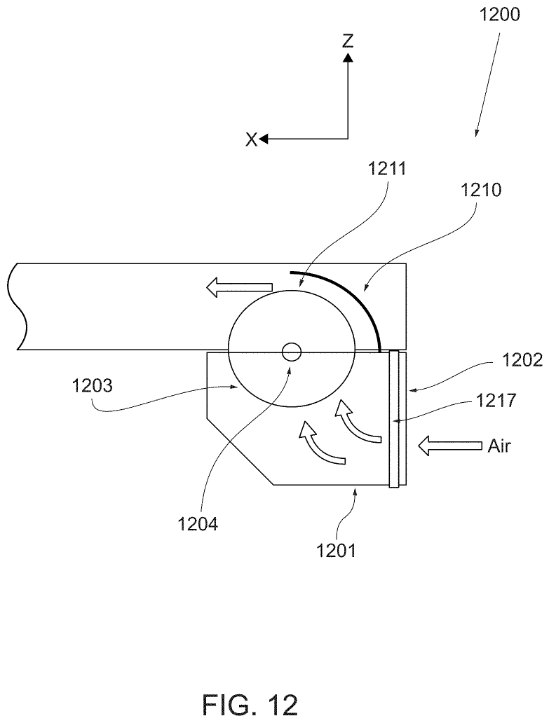

FIG. 12 shows a schematic cross-section view of an alternative embodiment 1200 of a CPAS system wherein a portion of the fan extends into the duct assembly. This embodiment is a variation of a tangential fan described above in relation to FIGS. 6A and 6B. In this embodiment, housing 1201 is disposed below a duct 1220 and defines a first air chamber for this embodiment. Housing 1201 has an inlet opening 1202 with a filter 1217 disposed therein to filter ambient air entering the housing 1201 through opening 1202. A tangential fan 1203 with its axis of rotation 1204 lying along the Y-axis is disposed near the top of the housing so its lower portion is within the housing and its upper portion is disposed within the duct assembly 1220. A slot around the tangential fan allows air to pass through the housing 1201 into duct 1220. Shroud 1210 extends into the duct 1220 to direct airflow around the fan 1203 to exit the fan tangentially through exit 1211 into duct 1220. The upper portion of housing 1201 and shroud 1210 define a second air chamber for this embodiment. As described above in relation to CPAS unit 1000, the CPAS unit 1200 is configured to fit within the footprint of the duct and tray assembly without extending into the space around the growing rack, impeding movement around the growing rack.

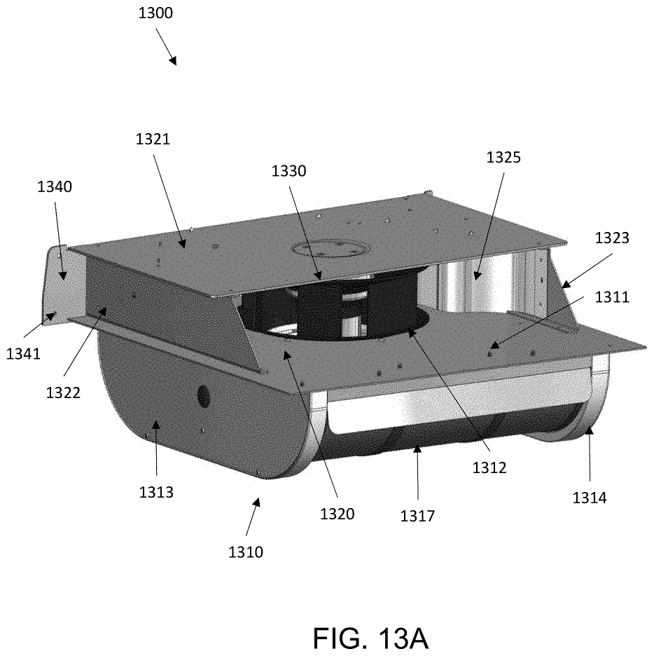

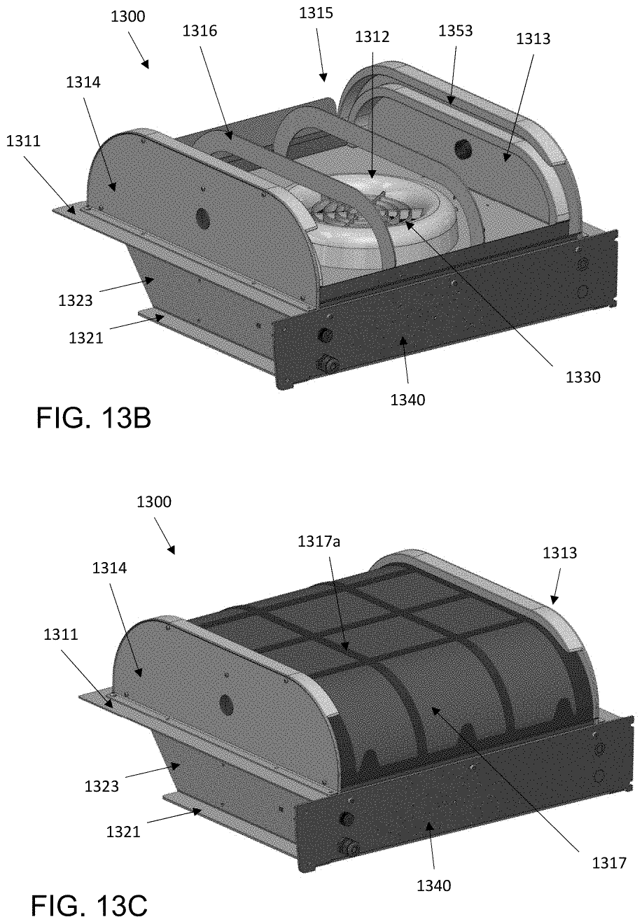

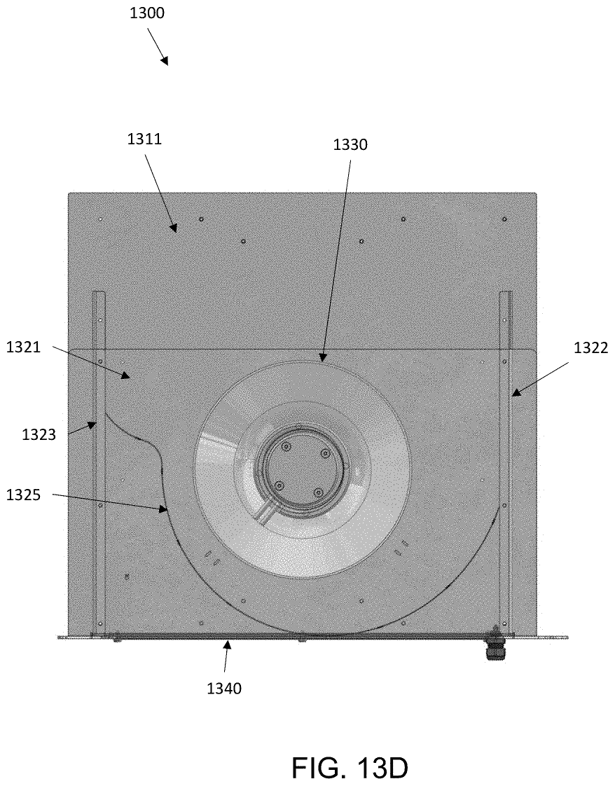

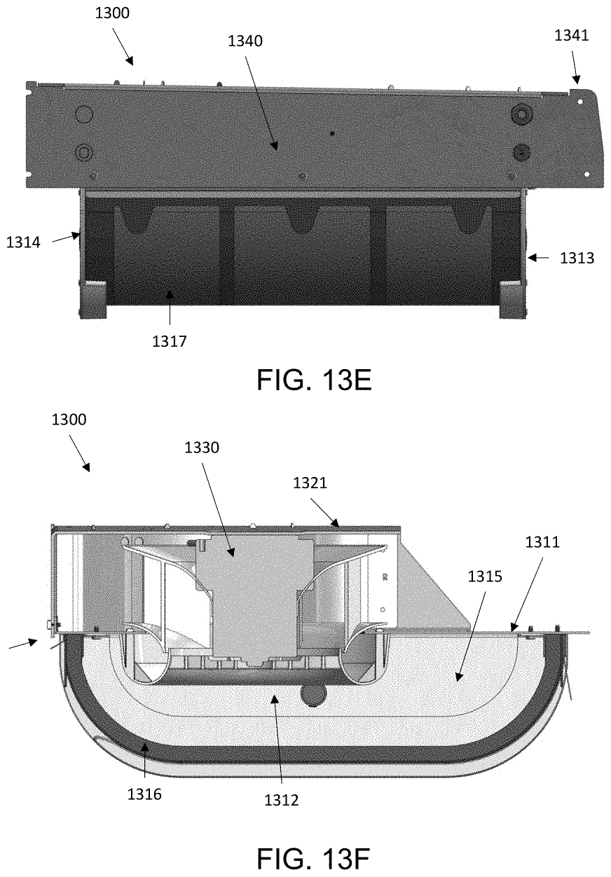

FIGS. 13A-F show aspects of another embodiment of a CPAS system 1300 with the fan integrated into the duct assembly. FIG. 13A shows a top perspective view of this embodiment. The lower housing 1310 comprises a plate 1311 with an opening 1312 configured to engage the inlet of a centrifugal fan 1330 so that the opening 1012 is in fluid communication with the interior of the centrifugal fan. The housing 1310 defines a first air chamber in this embodiment. Edges 1311a and 1311b of plate 1311 are configured to engage shelves and/or slots in side members 922a or 922b and center member 923 of a duct system 920 (not shown, see FIG. 10B for analogous connections). Sides 1313 and 1314 and plate 1311 define part of the boundary of a first air chamber 1315. As seen in bottom perspective view in FIG. 13B, curved framework members 1316 engaged below plate 1311 and between sides 1313 and 1314 combine with 1311, 1313 and 1314 to define a cavity or first air chamber inside the housing 1310. The open area 1318 among these parts provide an air inlet into the housing 1310. This air inlet is significantly larger than the inlet 1016 of CPAS unit 1100, allowing a greater amount of ambient air to be drawn into the air box and compressed by the fan 1330 to be directed into a duct assembly connected to the air box.

Returning to FIG. 13A, a second air chamber 1320 is defined by the top of plate 1311, top plate 1321 and sides 1322 and 1323. Fan 1330 is disposed within the second air chamber 1320. An outlet 1324 is bounded by 1311, 1321, 1322 and 1323 and is configured to direct air into duct system 920. A shroud 1325 is shown within second air chamber 1320 to help direct air toward the duct system 920. Back plate 1340 is engaged to the second air chamber to close that end. Back plate 1340 has end 1341 configured to engage a side support member of the duct system 920.

FIG. 13C shows a flexible filter 1317 disposed in the opening 1318 that provides for removal of particulates from the ambient air entering the first air chamber 1315 through the opening 1318. Filter 1317 may be slid into groove or channel 1352 on side 1312 and a corresponding groove or channel (not visible) on side 1313. Filter 1317 may comprise stiffening ribs 1317a.

FIG. 13D shows a top or plan view of the unit 1300, wherein top plate 1321 is shown as transparent to show objects below it. The shroud 1325 curves behind the fan 1330 so that air is directed toward the duct assembly 920 (not shown).

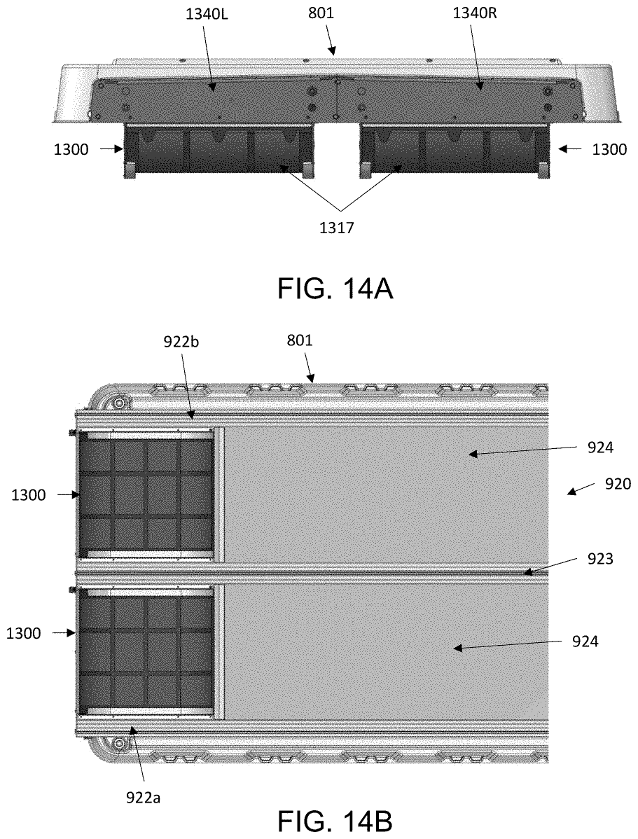

FIG. 13E shows an end view of the unit 1300. It can be seen that the top of end plate 1340 slopes slightly downward toward the right so that the upper (second) air chamber matches the trapezoidal cross-section of an air passage in duct assembly 920 (not shown) disposed below the valleys of tray 801 (also not shown, see FIG. 14A).

FIG. 13F shows a cross section of the unit 1300.

FIG. 14A shows two units 1300 disposed at the end of a duct system 920 (not shown). The end plates 1340L and 1340R are shown sloping downward from a center point below the center point of tray 801 to match the trapezoidal cross-sections of air passages in duct assembly 920 (not shown) disposed below the valleys of tray 801.

FIG. 14B shows a bottom view of two 1300 units disposed at the end of a duct system 920 under tray 801. One 1300 unit is disposed between side support 922a and center support 923 and a second 1300 unit is disposed between side support 922b and center support 923. Bottom panels 924 are disposed between center support 923 and side supports 922a or 922b. In the embodiment shown, bottom panels do not have openings so air is directed through the ventilation system 1300 down the duct system 920 and exits above the tray 801.

It can be appreciated that the lower housing 1310 comprising lower air chamber 1315 in embodiment 1300 can be adapted to replace the lower housing 1101 in embodiment 1100 and the lower housing 1201 in embodiment 1200 provide a first air chamber for those embodiments.

In the CPAS units shown in FIGS. 10A-10F, 11, 12 and 13A-F and 14A-B, the inlet is disposed in a housing disposed below the duct assembly. Alternatively, the inlets can be disposed above the duct assembly. These embodiments may be useful for installation at the lowest growing level of a vertical growing system, where space below the lowest level is limited or has an increased level of particulates relative to space above the lowest growing level.

### Embodiments

A first embodiment provides a system for plant cultivation, comprising: a ventilation system comprising an air box comprising an air passage extending from an inlet opening in a first end of the air box to an outlet opening in a second end of the air box, the air box comprising a filter disposed in the air passage proximate to the first end; and a centrifugal fan or tangential fan disposed in the air passage configured to move air from the first end to the second end of the air box.

Embodiments of the system comprise the following embodiments, alone or in any combination.

The system wherein the inlet opening has a greater area than the outlet opening.

The system wherein the inlet opening is generally rectangular, with a horizontal dimension greater than a vertical dimension.

The system wherein the outlet opening has a horizontal dimension greater than a vertical dimension.

The system wherein the first end of the air box has a vertical dimension greater than a vertical dimension of the second end of the air box.

The system wherein ambient air enters the inlet opening in a generally horizontal direction and air exits the outlet opening in a generally horizontal direction.

The system comprising a centrifugal fan having a vertical axis of rotation.

The system wherein the centrifugal fan comprises a plurality of curved impeller vanes.

The system comprising two or more centrifugal fans, each centrifugal fan having a vertical axis of rotation.

The system wherein each centrifugal fan comprises a plurality of curved impeller vanes.

The system comprising a centrifugal fan having a horizontal axis of rotation.

The system wherein the centrifugal fan comprises a volute housing wherein the outlet of the volute housing is in fluid communication with the outlet opening in the second end of the air box.

The system comprising a tangential fan having a horizontal axis of rotation, wherein the tangential fan directs air toward the outlet opening.

The system wherein the ventilation system further comprises a component to amend air before it exits the air passage.

The system wherein the component to amend air comprises a heater, cooler, dehumidifier, humidifier, carbon dioxide (CO₂) injector, ozone injector, ultraviolet light emitter, or combinations thereof.

The system wherein the air box is configured to attach to a rack system for supporting cultivated plants.

The system wherein the outlet opening is in fluid communication with an elongated duct assembly comprising one or more air passages, the duct assembly having a first end in fluid communication with the outlet opening, a second end opposed to the first end configured to be either closed or in fluid communication with a second duct assembly, and a plurality of orifices in the one or more air passages to distribute air out of the one or more air passages.

The system wherein the plurality of orifices are configured to direct air from the duct assembly to above the duct assembly; or direct air from the duct assembly to below the duct assembly; or direct air from the duct assembly to above and below the duct assembly.

The system wherein the one or more air passages in the duct assembly are each defined by an elongated bottom panel; a first elongated side member and a second elongated side member, each side member having a bottom end and a top end, wherein the bottom ends of the first and side members are engaged to opposed sides of the elongated bottom panel; and an elongated top panel with opposed first and second sides, the first side configured to engage the top end of the first side member and the second side configured to engage the top end of the second side member.

The system wherein the bottom panel comprises a plurality of orifices to direct air from the duct assembly to below the duct assembly.

The system wherein the top panel comprises a plurality of orifices to direct air from the duct assembly to above the duct assembly.

The system wherein the bottom panel comprises a plurality of orifices to direct air from the duct assembly to below the duct assembly and the top panel comprises a plurality of orifices to direct air from the duct assembly to above the duct assembly.

The system further comprising a tray comprising opposed side walls and opposed ends defining a perimeter of the tray, and a raised region disposed within the perimeter of the tray.

The system wherein the raised region of the tray comprises: a plurality of alternating parallel ridges disposed between the side walls and a plurality of valleys formed between adjacent ridges of the plurality of ridges, wherein one or more of the plurality of valleys are in fluid communication with a gutter; and optionally one or more of a plurality of holes in one or more of the plurality of ridges.

The system wherein the plurality of holes are present and are in fluid communication with the plurality of orifices in the top panel of the duct assembly to direct air from the duct assembly to above the tray.

The system wherein the bottom surface of the raised region of the tray comprises the top panel of the duct assembly.

The system wherein the plurality of alternating parallel ridges comprise top surfaces defining a level plane for supporting one or more individual growing containers for containing growth medium and plants, and the plurality of valleys slope downward from a peak to a gutter proximate to the perimeter of the upper tray, the one or more of the plurality of valleys are in fluid communication with the gutter for channeling fluid collected into the gutter.

The system wherein the gutter is configured to be in fluid communication with a fluid drainage system.

Additional embodiments include the following, alone or in any combination.

Embodiment 1. A system for plant cultivation, comprising a ventilation system comprising an air box comprising an air passage extending from an inlet opening in a first end of the air box to an outlet opening in a second end of the air box, the air box comprising a centrifugal fan or tangential fan disposed in the air passage configured to move air from the first end to the second end of the air box.

Embodiment 2. The system of Embodiment 1 comprising a centrifugal fan having a vertical axis of rotation.

Embodiment 3. The system of Embodiment 2 wherein the centrifugal fan comprises a plurality of curved impeller vanes.

Embodiment 4. The system of Embodiment 2 comprising two or more centrifugal fans, each centrifugal fan having a vertical axis of rotation.

Embodiment 5. The system of Embodiment 2 wherein the inlet opening has a greater area than the outlet opening.

Embodiment 6. The system of Embodiment 2 wherein the inlet opening is generally rectangular, with a horizontal dimension greater than a vertical dimension.

Embodiment 7. The system of Embodiment 2 wherein the outlet opening has a horizontal dimension greater than a vertical dimension.

Embodiment 8. The system of Embodiment 2 wherein the first end of the air box has a vertical dimension greater than a vertical dimension of the second end of the air box.

Embodiment 9. The system of Embodiment 1 wherein ambient air enters the inlet opening in a generally horizontal direction and air exits the outlet opening in a generally horizontal direction.

Embodiment 10. The system of Embodiment 9 wherein each centrifugal fan comprises a plurality of curved impeller vanes.

Embodiment 11. The system of Embodiment 1 comprising a centrifugal fan having a horizontal axis of rotation.

Embodiment 12. The system of Embodiment 11 wherein the centrifugal fan comprises a volute housing wherein the outlet of the volute housing is in fluid communication with the outlet opening in the second end of the air box.

Embodiment 13. The system of Embodiment 11 wherein the inlet opening has a greater area than the outlet opening.

Embodiment 14. The system of Embodiment 11 wherein the inlet opening is generally rectangular, with a horizontal dimension greater than a vertical dimension.

Embodiment 15. The system of Embodiment 11 wherein the outlet opening has a horizontal dimension greater than a vertical dimension.

Embodiment 16. The system of Embodiment 11 wherein the first end of the air box has a vertical dimension greater than a vertical dimension of the second end of the air box.

Embodiment 17. The system of Embodiment 11 wherein ambient air enters the inlet opening in a generally horizontal direction and air exits the outlet opening in a generally horizontal direction.

Embodiment 18. The system of Embodiment 1 comprising a tangential fan having a horizontal axis of rotation, wherein the tangential fan directs air toward the outlet opening.

Embodiment 19. The system of Embodiment 18 wherein the inlet opening is generally rectangular, with a horizontal dimension greater than a vertical dimension.

Embodiment 20. The system of Embodiment 18 wherein the outlet opening has a horizontal dimension greater than a vertical dimension.

Embodiment 21. The system of Embodiment 18 wherein the first end of the air box has a vertical dimension greater than a vertical dimension of the second end of the air box.

Embodiment 22. The system of Embodiment 18 wherein ambient air enters the inlet opening in a generally horizontal direction and air exits the outlet opening in a generally horizontal direction.

Embodiment 23. The system of Embodiment 1 wherein the air box comprising a filter disposed in the air passage proximate to the first end.

Embodiment 24. The system of Embodiment 1, wherein the ventilation system further comprises a component to amend air before it exits the air passage.

Embodiment 25. The system of Embodiment 1, wherein the component to amend air comprises a heater, cooler, dehumidifier, humidifier, carbon dioxide (CO₂) injector, ozone injector, ultraviolet light emitter, or combinations thereof.

Embodiment 26. The system of Embodiment 1, wherein the air box is configured to attach to a rack system for supporting cultivated plants.

Embodiment 27. The system of Embodiment 1 wherein the outlet opening is in fluid communication with an elongated duct assembly comprising one or more air passages, the duct assembly having a first end in fluid communication with the outlet opening, a second end opposed to the first end configured to be either closed or in fluid communication with a second duct assembly, and a plurality of orifices in the one or more air passages to distribute air out of the one or more air passages.

Embodiment 28. The system of Embodiment 27 wherein the plurality of orifices are configured to direct air from the duct assembly to above the duct assembly; or direct air from the duct assembly to below the duct assembly; or direct air from the duct assembly to above and below the duct assembly.

Embodiment 29. The system of Embodiment 27 wherein the one or more air passages in the duct assembly are each defined by an elongated bottom panel; a first elongated side member and a second elongated side member, each side member having a bottom end and a top end, wherein the bottom ends of the first and side members are engaged to opposed sides of the elongated bottom panel; and an elongated top panel with opposed first and second sides, the first side configured to engage the top end of the first side member and the second side configured to engage the top end of the second side member.

Embodiment 30. The system of Embodiment 29 wherein the bottom panel comprises a plurality of orifices to direct air from the duct assembly to below the duct assembly.

Embodiment 31. The system of Embodiment 29 wherein the top panel comprises a plurality of orifices to direct air from the duct assembly to above the duct assembly.

Embodiment 32. The system of Embodiment 29 wherein the bottom panel comprises a plurality of orifices to direct air from the duct assembly to below the duct assembly and the top panel comprises a plurality of orifices to direct air from the duct assembly to above the duct assembly.

Embodiment 33. The system of Embodiment 27 further comprising a tray comprising opposed sides and opposed ends defining a perimeter of the tray, and a raised region disposed within the perimeter of the tray.

Embodiment 34. The system of Embodiment 33, wherein the raised region of the tray comprises: a plurality of alternating parallel ridges disposed between the side walls and a plurality of valleys formed between adjacent ridges of the plurality of ridges, wherein one or more of the plurality of valleys are in fluid communication with a gutter; and optionally one or more of a plurality of holes in one or more of the plurality of ridges.

Embodiment 35. The system of Embodiment 34 wherein the plurality of holes are present and are in fluid communication with the plurality of orifices in the top panel of the duct assembly to direct air from the duct assembly to above the tray.

Embodiment 36. The system of Embodiment 35 wherein the bottom surface of the raised region of the tray comprises the top panel of the duct assembly.

Embodiment 37. The system of Embodiment 33, wherein the plurality of alternating parallel ridges comprise top surfaces defining a level plane for supporting one or more individual growing containers for containing growth medium and plants, and the plurality of valleys slope downward from a peak to a gutter proximate to the perimeter of the upper tray, the one or more of the plurality of valleys are in fluid communication with the gutter for channeling fluid collected into the gutter.

Embodiment 38. The system of Embodiment 37, wherein the gutter is configured to be in fluid communication with a fluid drainage system.

Embodiment 39. The system of Embodiment 27 wherein the duct assembly is engaged to an air box comprising an air passage extending from an inlet opening in a first end of the air box to an outlet opening in a second end of the air box, the air box comprising a centrifugal fan having a vertical axis of rotation disposed in the air passage configured to move air from the first end to the second end of the air box.

Embodiment 40. The system of Embodiment 27 wherein the duct assembly is engaged to an air box comprising an air passage extending from an inlet opening in a first end of the air box to an outlet opening in a second end of the air box, the air box comprising a centrifugal fan having a horizontal axis of rotation disposed in the air passage configured to move air from the first end to the second end of the air box.

Embodiment 41. The system of Embodiment 27 wherein the duct assembly is engaged to an air box comprising an air passage extending from an inlet opening in a first end of the air box to an outlet opening in a second end of the air box, the air box comprising a tangential fan having a horizontal axis of rotation disposed in the air passage configured to move air from the first end to the second end of the air box.

Embodiment 42. The system of Embodiment 27 wherein the duct assembly is engaged to an air box comprising a first air chamber extending from an inlet opening in a first end of the air box and a second air chamber extending from an outlet opening in a second end of the air box and a centrifugal fan or a tangential fan disposed between the first air chamber and the second air chamber, the fan in fluid connectivity with the first air chamber and the second air chamber to define an air passage configured to move air from the first end to the second end of the air box.

Embodiment 43. The system of Embodiment 42 wherein the second air chamber is configured to fit within an air passage within the duct assembly and the outlet directs air into an air passage within the duct assembly.

Embodiment 44. The system of Embodiment 43 wherein at least a portion of the centrifugal fan or at least a portion of the tangential fan is disposed within the second air chamber.

Embodiment 45. The system of Embodiment 44 wherein the centrifugal fan has a vertical axis of rotation and an entry in fluid communication with the first air chamber.

Embodiment 46. The system of Embodiment 45 wherein the centrifugal fan is disposed within the second air chamber.

Embodiment 47. The system of Embodiment 44 wherein the centrifugal fan has a horizontal axis of rotation and an entry in fluid communication with the first air chamber.

Embodiment 48. The system of Embodiment 47 wherein the centrifugal fan has a housing wherein the entry is disposed within the first air chamber and an exit is disposed in the second air chamber.

Embodiment 49. The system of Embodiment 44 wherein the tangential fan has a horizontal axis of rotation and an entry in fluid communication with the first air chamber.

Embodiment 50. The system of Embodiment 49 wherein the tangential fan has a housing wherein the entry is disposed within the first air chamber and an exit is disposed in the second air chamber.

Embodiment 51. A system for plant cultivation, comprising a ventilation system comprising an air box comprising a first air chamber extending from an inlet opening in a first end of the air box and a second air chamber extending from an outlet opening in a second end of the air box and a centrifugal fan or a tangential fan disposed between the first air chamber and the second air chamber, the fan in fluid connectivity with the first air chamber and the second air chamber to define an air passage configured to move air from the first end to the second end of the air box.

Embodiment 52. The system of Embodiment 51 wherein the air box is configured to engage a duct assembly to draw ambient air into the air box through the inlet opening and direct compressed air through the outlet opening into the duct assembly.

Embodiment 53. The system of Embodiment 52 wherein the outlet opening is in fluid communication with an elongated duct assembly comprising one or more air passages, the duct assembly having a first end in fluid communication with the outlet opening, a second end opposed to the first end configured to be either closed or in fluid communication with a second duct assembly, and a plurality of orifices in the one or more air passages to distribute air out of the one or more air passages.

Embodiment 54. The system of Embodiment 52 wherein the second air chamber is configured to fit within an air passage within the duct assembly and the outlet directs air into an air passage within the duct assembly.

Embodiment 55. The system of Embodiment 54 wherein at least a portion of the centrifugal fan or at least a portion of the tangential fan is disposed within the second air chamber.

Embodiment 56. The system of Embodiment 55 wherein the centrifugal fan has a vertical axis of rotation and an entry in fluid communication with the first air chamber.

Embodiment 57. The system of Embodiment 56 wherein the centrifugal fan is disposed within the second air chamber.

Embodiment 58. The system of Embodiment 54 wherein the centrifugal fan has a horizontal axis of rotation and an entry in fluid communication with the first air chamber.

Embodiment 59. The system of Embodiment 58 wherein the centrifugal fan has a housing wherein the entry is disposed within the first air chamber and an exit is disposed in the second air chamber.

Embodiment 60. The system of Embodiment 44 wherein the tangential fan has a horizontal axis of rotation and an entry in fluid communication with the first air chamber.

Embodiment 61. The system of Embodiment 60 wherein the tangential fan has a housing wherein the entry is disposed within the first air chamber and an exit is disposed in the second air chamber.

Embodiment 62. The system of Embodiment 52 wherein the plurality of orifices are configured to direct air from the duct assembly to above the duct assembly; or direct air from the duct assembly to below the duct assembly; or direct air from the duct assembly to above and below the duct assembly.

Embodiment 63. The system of Embodiment 52 further comprising a tray comprising opposed sides and opposed ends defining a perimeter of the tray, and a raised region disposed within the perimeter of the tray.

Embodiment 64. The system of Embodiment 63, wherein the raised region of the tray comprises: a plurality of alternating parallel ridges disposed between the side walls and a plurality of valleys formed between adjacent ridges of the plurality of ridges, wherein one or more of the plurality of valleys are in fluid communication with a gutter; and optionally one or more of a plurality of holes in one or more of the plurality of ridges.

Embodiment 65. The system of Embodiment 64 wherein the plurality of holes are present and are in fluid communication with the plurality of orifices in the top panel of the duct assembly to direct air from the duct assembly to above the tray.

Embodiment 66. The system of Embodiment 65 wherein the bottom surface of the raised region of the tray comprises the top panel of the duct assembly.

Many alternatives, modifications, and variations are enabled by the present disclosure. While specific embodiments have been shown and described in detail to illustrate the application of the principles of the invention, it will be understood that the exemplary embodiments may be embodied otherwise without departing from such principles. Accordingly, Applicants intend to embrace all such alternatives, modifications, equivalents, and variations that are within the spirit and scope of the exemplary embodiments.

1. A system for plant cultivation, comprising a ventilation system comprising an air box comprising an air passage extending from an inlet opening in a first end of the air box to an outlet opening in a second end of the air box, the air box comprising a centrifugal fan or tangential fan disposed in the air passage configured to move air from the first end to the second end of the air box.

2. The system of claim 1 comprising a centrifugal fan having a vertical axis of rotation.

3. The system of claim 2 comprising two or more centrifugal fans, each centrifugal fan having a vertical axis of rotation.

4. The system of claim 1 comprising a centrifugal fan having a horizontal axis of rotation.

5. The system of claim 4 wherein the centrifugal fan comprises a volute housing wherein the outlet of the volute housing is in fluid communication with the outlet opening in the second end of the air box.

6. The system of claim 1 comprising a tangential fan having a horizontal axis of rotation, wherein the tangential fan directs air toward the outlet opening.

7. The system of claim 1 wherein the outlet opening is in fluid communication with an elongated duct assembly comprising one or more air passages, the duct assembly having a first end in fluid communication with the outlet opening, a second end opposed to the first end configured to be either closed or in fluid communication with a second duct assembly, and a plurality of orifices in the one or more air passages to distribute air out of the one or more air passages.

8. The system of claim 7 wherein the plurality of orifices are configured to:
direct air from the duct assembly to above the duct assembly; or
direct air from the duct assembly to below the duct assembly; or
direct air from the duct assembly to above and below the duct assembly.

9. The system of claim 7 wherein the duct assembly is engaged to an air box comprising a first air chamber extending from an inlet opening in a first end of the air box and a second air chamber extending from an outlet opening in a second end of the air box and a centrifugal fan or a tangential fan disposed between the first air chamber and the second air chamber, the fan in fluid connectivity with the first air chamber and the second air chamber to define an air passage configured to move air from the first end to the second end of the air box.

10. The system of claim 9 wherein the second air chamber is configured to fit within an air passage within the duct assembly and the outlet directs air into an air passage within the duct assembly.

11. The system of claim 10 wherein the centrifugal fan has a vertical axis of rotation and an entry in fluid communication with the first air chamber; and the centrifugal fan is disposed within the second air chamber.

12. A system for plant cultivation, comprising a ventilation system comprising an air box comprising a first air chamber extending from an inlet opening in a first end of the air box and a second air chamber extending from an outlet opening in a second end of the air box and a centrifugal fan or a tangential fan disposed between the first air chamber and the second air chamber, the fan in fluid connectivity with the first air chamber and the second air chamber to define an air passage configured to move air from the first end to the second end of the air box.

13. The system of claim 12 wherein the air box is configured to engage a duct assembly to draw ambient air into the air box through the inlet opening and direct compressed air through the outlet opening into the duct assembly.

14. The system of claim 12 wherein the outlet opening is in fluid communication with an elongated duct assembly comprising one or more air passages, the duct assembly having a first end in fluid communication with the outlet opening, a second end opposed to the first end configured to be either closed or in fluid communication with a second duct assembly, and a plurality of orifices in the one or more air passages to distribute air out of the one or more air passages.

15. The system of claim 12 wherein the second air chamber is configured to fit within an air passage within the duct assembly and the outlet directs air into an air passage within the duct assembly.

16. The system of claim 15 wherein the centrifugal fan has a vertical axis of rotation and an entry in fluid communication with the first air chamber.

17. The system of claim 16 wherein the centrifugal fan is disposed within the second air chamber.

18. The system of claim 12 wherein the plurality of orifices are configured to:
direct air from the duct assembly to above the duct assembly; or
direct air from the duct assembly to below the duct assembly; or
direct air from the duct assembly to above and below the duct assembly.

19. The system of claim 12 further comprising a tray comprising opposed sides and opposed ends defining a perimeter of the tray, and a raised region disposed within the perimeter of the tray.

20. The system of claim 19, wherein the raised region of the tray comprises:
a plurality of alternating parallel ridges disposed between the side walls and a plurality of valleys formed between adjacent ridges of the plurality of ridges, wherein one or more of the plurality of valleys are in fluid communication with a gutter; and optionally one or more of a plurality of holes in one or more of the plurality of ridges in fluid communication with the plurality of orifices in the top panel of the duct assembly to direct air from the duct assembly to above the tray.
